(19) United States
(12) Patent Application Publication
(10) Pub. No.: US 2024/0209529 A1
(43) Pub. Date: Jun. 27, 2024

(54) ANODIC ELECTRODE, WATER ELECTROLYSIS DEVICE INCLUDING THE SAME AND METHOD FOR PREPARING THE SAME

(71) Applicant: KOREA INSTITUE OF SCIENCE AND TECHNOLOGY, Seoul (KR)

(72) Inventors: Hyun S. PARK, Seoul (KR); Sung Jong Yoo, Seoul (KR); Jong Hyun Jang, Seoul (KR); Sung Ki Cho, Seoul (KR); Hee-Young Park, Seoul (KR); Gyu Seong Yi, Seoul (KR); Jin-ho Oh, Seoul (KR); Hui-Yun Jeong, Seoul (KR)

(21) Appl. No.: 18/508,891

(22) Filed: Nov. 14, 2023

(30) Foreign Application Priority Data
Dec. 22, 2022 (KR) 10-2022-0181577

(51) Int. Cl. C25B 11/091; C25B 1/04; C25B 11/053; C25B 11/063

(52) U.S. Cl. CPC C25B 11/091; C25B 1/04; C25B 11/053; C25B 11/063

(57) ABSTRACT

Disclosed herein are an anodic electrode, a water electrolysis device including the same, and a method of preparing the same. Exemplary embodiments of the present disclosure may provide an anodic electrode that has excellent performance while lowering a loading amount of noble metal, particularly iridium oxide by forming a metal nitride layer on a substrate and forming an iridium oxide layer on the metal nitride layer by an electrodeposition.

### CROSS-REFERENCE TO RELATED APPLICATION

This application claims priority to Korean Patent Application No. 10-2022-0181577, filed on Dec. 22, 2022, and all the benefits accruing therefrom under 35 U.S.C. § 119, the contents of which in its entirety are herein incorporated by reference.

### TECHNICAL FIELD

This invention was made with the support of the Ministry of Science and ICT under Project No. 1711173294, which was conducted under the research project entitled “Development of Green Hydrogen Production-Liquid Storage Integrated Technology” within the project named “Support for research and operation expenses of the Korea Institute of Science and Technology” under the management of the Korea Institute of Science and Technology, from Jan. 1, 2022 to Dec. 31, 2022.

This invention was made with the support of the Ministry of Trade, Industry and Energy under Project No. 1415180391, which was conducted under the research project entitled “Development of highperformance catalytic electrodes and parts technology on 2.5 kWclass AEM water electrolysis using wastealkali solution for hydrogen production” within the project named “Materials/Parts Technology Development” under the management of the Korea Evaluation Institute Of Industrial Technology, from Apr. 1, 2022 to Dec. 31, 2022.

This invention was made with the support of the Ministry of Trade, Industry and Energy under Project No. 1415181329, which was conducted under the research project entitled “Development of Robust Polymer Electrolyte Membrane and Multiscale Interface Control for High Efficiency PEM Electrolysis” within the project named “New Renewable Energy Core Technology Development” under the management of the Korea Energy Technology Evaluation and Planning, from Apr. 1, 2022 to Dec. 31, 2022.

This invention was made with the support of the Ministry of Science and ICT under Project No. 1711159906, which was conducted under the research project entitled “Development of multi-component/thin-layer non-Pt precious metal electrocatalysts towards HER and water electrolysis electrodes/MEAs through optimizations of adsorption strength and mass transport” within the project named “Nano. Material Technology Development (R & D)” under the management of the National Research Foundation of Korea, from Jan. 1, 2022 to Dec. 31, 2022.

This invention was made with the support of the Ministry of Economy and Finance under Project No. 1055000973, which was conducted under the research project entitled “Development of large-scale aqueous ammonia electrolysis system for high-efficiency hydrogen extraction” within the project named “Development of Future Hydrogen Source Technology” under the management of the National Research Foundation of Korea, from Jul. 1, 2022 to Dec. 31, 2022.

The present specification relates to an anodic electrode, a water electrolysis device including the same, and a method of preparing the same. More specifically, the present specification relates to an anodic electrode including an iridium oxide layer formed by an electrodeposition on a metal nitride layer, a water electrolysis device including the same, and a method of preparing the same.

### BACKGROUND ART

Various water electrolysis systems are being developed as hydrogen, which is clean energy, is used as energy in order to replace fossil energy. Water electrolysis technology may be largely divided into alkaline water electrolysis and proton exchange membrane water electrolysis. The proton exchange membrane water electrolysis has an advantage of high operating pressure/current density and high purity of generated hydrogen, but has a disadvantage of requiring an excessive amount of noble metal when preparing an electrode. In particular, since a solid polymer water electrolysis cell uses a membrane electrode assembly (MEA) which is a structure in which an anodic electrode and a cathode are coated on both sides around a solid polymer electrolyte membrane composed of polymer material, the solid polymer water electrolysis cell is very safe, may be operated at low temperatures, and is very efficient compared to the existing alkaline water electrolysis.

However, recently the proton exchange membrane water electrolysis requires an excessive amount of noble metal catalyst when preparing the electrode, thereby resulting in a very high system cost. In the meantime, an oxygen evolution reaction during water electrolysis operation at an anodic electrode has used an excessive amount of noble metal catalyst due to a slow reaction. Various studies have been conducted to reduce the amount of noble metal catalyst, Korean Patent Publication No. 10-2019-0046074 discloses an oxygen electrode comprising a dual plating catalyst, water electrolysis device, regenerative fuel cell including the same and method for preparing the oxygen electrode. However, platinum is also widely used in fuel cells and is very expensive, therefore it is necessary to replace the platinum.

### DISCLOSURE

### Technical Problem

The present disclosure has been made in an effort to provide an anodic electrode with excellent performance while lowering a loading amount of iridium oxide, more specifically, to provide a method of preparing an anodic electrode including an iridium oxide layer formed on a metal nitride layer by an electrodeposition, and a method of preparing a water electrolysis device including the anodic electrode.

### Technical Solution

In one aspect, exemplary embodiments of the present disclosure provide an anodic electrode including a substrate; a metal nitride layer formed on the substrate; and an iridium oxide layer formed by an electrodeposition on the metal nitride layer.

In one aspect, exemplary embodiments of the present disclosure provide a water electrolysis device including the anodic electrode.

In one aspect, exemplary embodiments of the present disclosure provide a method of preparing the anodic electrode, the method including: forming a metal oxide layer including metal oxide nanowires on a substrate; forming a metal nitride layer including metal nitride nanowires by nitriding the metal oxide nanowires; and forming an iridium oxide layer on the metal nitride layer by an electrodeposition.

### Advantageous Effect

Exemplary embodiments of the present disclosure may provide an anodic electrode that has excellent performance while lowering a loading amount of noble metal, particularly iridium oxide by forming a metal nitride layer on a substrate and forming an iridium oxide layer on the metal nitride layer by the electrodeposition.

### DESCRIPTION OF DRAWINGS

FIG. 1 is a schematic view illustrating a surface of an anodic electrode according to an embodiment of the present disclosure.

FIG. 2 illustrates time-current data for an electrochemical deposition of an iridium oxide layer.

FIGS. 3A, 3B, 5A, and 5B are SEM images illustrating anodic electrode catalyst morphologies according to the embodiment of the present disclosure.

FIGS. 4 and 6 are images illustrating an XRD spectrum of an anodic electrode catalyst according to the embodiment of the present disclosure.

FIGS. 7A and 7B are a SEM images illustrating the anodic electrode catalyst morphologies according to the embodiment of the present disclosure.

FIGS. 8A, 8B, and 8C illustrate SEM images illustrating the anodic electrode catalyst morphologies and graphs illustrating electrical resistance according to the embodiment of the present disclosure.

FIGS. 9A and 9B are XPS images illustrating composition of the anodic electrode catalyst according to the embodiment of the present disclosure.

FIG. 10 is SEM images illustrating the anodic electrode surface morphologies according to the embodiment of the present disclosure.

FIGS. 11A, 11B, 11C, and 11D are images illustrating line scanning analysis results of the anodic electrode according to the embodiment of the present disclosure.

FIG. 12 is an ICP-AES image illustrating an iridium loading amount of the anodic electrode according to the embodiment of the present disclosure.

FIGS. 13A and 13B are an XPS images illustrating composition of the anodic electrode according to the embodiment of the present disclosure.

FIGS. 14A and 14B are graphs illustrating cyclic voltammetry (CV) curves of the anodic electrode according to the embodiment of the present disclosure.

FIGS. 15A, 15B, 15C, and 15D illustrate STEM-HAADF images and EDS images of the anodic electrode according to the embodiment of the present disclosure.

FIGS. 16A, 16B, and 16C are graphs illustrating I-V polarization curves of a water electrolysis device including the anodic electrode according to the embodiment of the present disclosure.

FIGS. 17A, 17B, 17C, 17D, 17E, 17F, 17G, and 17H are graphs illustrating Nyquist plots, which are measurement results and a method of measuring impedance of the water electrolysis device including the anodic electrode according to the embodiment of the present disclosure.

FIGS. 18A, 18B, and 19 are graphs illustrating mass activity of the water electrolysis device including the anodic electrode according to the embodiment of the present disclosure.

FIG. 20 is a graph illustrating a ratio (R_{hf}/R_{lf}) of high frequency resistance (R_{hf}) and low frequency resistance (R_{lf}) in the anodic electrode according to the embodiment of the present disclosure.

FIGS. 21A, 21B, 21C, 21D, 22A, 22B, 22C, and 22D are graphs illustrating stability evaluation results and LSV polarization curves of the water electrolysis device including the anodic electrode according to the embodiment of the present disclosure.

FIGS. 23A, 23B, 23C, and 23D are SEM-WDS images illustrating a cross section of the anodic electrode according to the embodiment of the present disclosure.

FIG. 24 is a schematic view illustrating the anodic electrode polishing according to the embodiment of the present disclosure.

FIGS. 25A, 25B, and 25C are EPMA images illustrating Ir distribution of the anodic electrode according to the embodiment of the present disclosure.

FIGS. 26A, 26B, and 26C are graphs illustrating I-V polarization curves of the water electrolysis device including the anodic electrode according to the embodiment of the present disclosure.

FIGS. 27A and 27B are schematic views illustrating an operation of the anodic electrode according to the embodiment of the present disclosure.

### MODE FOR INVENTION

The terms used in the present specification are selected from general terms currently widely used in the art in consideration of functions in the present disclosure, but the terms may vary according to the intention of those skilled in the art, precedents, or new technology in the art. Further, specified terms are selected arbitrarily by the applicant, and in this case, the detailed meaning thereof will be described in the detailed description of the invention. Thus, the terms used in the present specification should be defined based on not simple names but the meaning of the terms and the overall description of the present disclosure.

Unless otherwise defined, all terms used herein, including technical or scientific terms, have the same meaning as commonly understood by those skilled in the art to which the present disclosure pertains. The terms which are commonly understood should be interpreted as having meanings consistent with meanings in the context of related technologies and should not be interpreted as ideal or excessively formal meanings unless explicitly defined in the present disclosure.

Numerical value ranges are inclusive of the values defined in the present disclosure. Every maximum numerical limitation given throughout the present specification includes every lower numerical limitation, as if such lower numerical limitations were expressly written. Every minimum numerical limitation given throughout the present specification includes every higher numerical limitation, as if such higher numerical limitations were expressly written. Every numerical limitation given throughout the present specification will include every better numerical range within the broader numerical range, as if the narrower numerical limitations were expressly written.

As used in the present specification, the words “comprising”, “having”, “including” are inclusive or open-ended and do not exclude additional unrecited elements or method steps. The term “or combinations thereof” used in the present specification refers to all permutations and combinations of the items listed preceding the term. For example, “A, B, C, or combinations thereof” is intended to be A, B, C, AB, AC, BC, or ABC, and to include at least one of BA, CA, CB, CBA, BCA, ACB, BAC or CAB, where order is important in a particular context. With the example above, “A, B, C, or combinations thereof” may include combinations containing repetitions of one or more items or terms, such as BB, AAA, MB, BBC, AAABCCCC, CBBAAA, CABABB, and the like. Those skilled in the art will understand that there is typically no limit to the number of items or terms in any combination, unless the context clearly indicates otherwise. Hereinafter, exemplary embodiments of the present disclosure will be described in detail with reference to the drawings. However, it is apparent that the present disclosure is not limited by the following embodiments.

### Anodic Electrode

In one aspect, exemplary embodiments of the present disclosure provide an anodic electrode including a substrate; a metal nitride layer formed on the substrate; and an iridium oxide layer formed by an electrodeposition on the metal nitride layer.

Iridium (Ir) is considered the most suitable material for maintaining a balance between stability and activity for an oxygen evolution reaction (OER, H₂O→2H⁺+1/2O₂+2e⁻) occurring at an anodic electrode of a water electrolysis device. However, in particular, a scarcity and high price of iridium, which is only produced in several tons per year, is considered a potential obstacle to the realization of large-scale commercialization of the water electrolysis device. Accordingly, the present inventors developed the anodic electrode that has excellent performance while lowering a loading amount of iridium oxide by forming the iridium oxide layer on the metal nitride layer by the electrodeposition.

A chemical formula of iridium oxide may be IrO_{X}, and the x may be 1.5 to 2.5. The iridium oxide layer is electrodeposited on the metal nitride layer so that the metal nitride layer is not exposed.

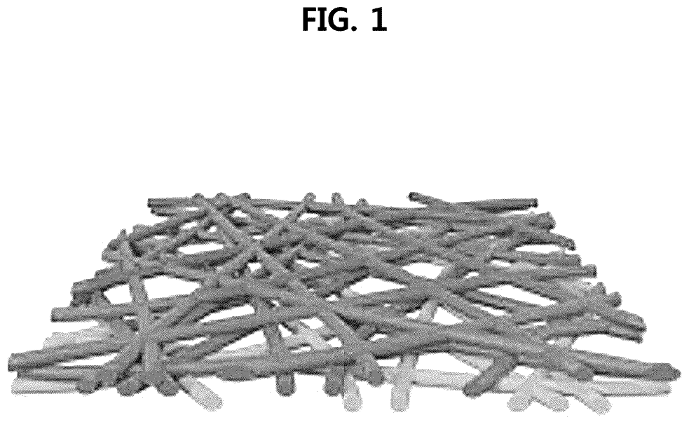

FIG. 1 is a schematic view illustrating a surface of the anodic electrode according to an embodiment of the present disclosure. The metal nitride layer serves as a support body for the iridium oxide layer. The metal nitride layer is an ideal electrochemical core material because the metal nitride layer has superior electrical conductivity compared to a metal oxide layer. In addition, the metal nitride layer serves as a core in a core-shell structure of the metal nitride layer-iridium oxide layer. Accordingly, a loading amount of iridium oxide may be reduced. In addition, corrosion of the metal nitride layer in an acidic environment is overcome by being passivated by the iridium oxide layer serving as a shell. In general, since metal nitride has low chemical stability under acidic electrochemical conditions, an electrochemical application as an oxygen evolution reaction (OER) catalyst is limited to basic electrochemical conditions. Accordingly, the present inventors have completed the present disclosure by finding that passivating the metal nitride layer with the iridium oxide layer allows high stability under acidic and oxidizing conditions and also achieves high mass activity of platinum group metals. Further, stability of an electrode of the water electrolysis device is one of the important functions for economical green hydrogen production. Since platinum group metals are robust under severe corrosive conditions, the platinum group metals are widely used as protective layers and active catalysts. However, since the use of a significant amount of platinum group metal in the anodic electrode hinders the deployment of the water electrolysis device in the field, the present inventors achieved water electrolysis performance by using metal nitride instead of platinum.

The metal nitride layer, as a self-supporting body of the iridium oxide layer, not only enlarges a surface area of an active catalyst, but also provides a morphological advantage at an interface between a polymer separator and an electrode.

According to the embodiment of the present disclosure, the metal nitride layer includes metal nitride nanowires. The term “nanowire” refers to a fine wire whose cross-sectional diameter is in unit of nanometers (nm). Although the term “nanowire” is used throughout the detailed description herein for purposes of illustration, the term also includes the use of a nanorod or a nanotube.

According to the embodiment of the present disclosure, the metal nitride nanowires are oriented in at least one or more directions. The nanowires may be regularly oriented by polarization using a polar solvent as a nanowire dispersing solvent, and furthermore, the nanowires may be regularly oriented by applying an electric field to the polar solvent. Meanwhile, in order to increase a surface area of the anodic electrode, the nanowires may be randomly oriented in any direction.

According to the embodiment of the present disclosure, the metal nitride nanowires have rough surfaces. In step of forming the metal oxide layer including the metal oxide nanowires on the substrate, conditions such as formation time may affect the surface roughness of the metal nitride nanowires. As the surface roughness of the metal nitride nanowires increases, excellent performance is exhibited at the anodic electrode. According to the embodiment of the present disclosure, a diameter of the metal nitride nanowire is 10 nm to 100 nm, and a length of the metal nitride nanowire is 200 nm to 800 nm. More specifically, the diameter of the metal nitride nanowire may be 10 nm or more, 20 nm or more, 30 nm or more, 40 nm or more, 50 nm or more, 60 nm or more; and the diameter of the metal nitride nanowire may be 100 nm or less, 90 nm or less, 80 nm or less, 70 nm or less, or 60 nm or less, but is not limited thereto. More specifically, the length of the metal nitride nanowire may be 200 nm or more, 300 nm or more, 400 nm or more, 500 nm or more; and the length of the metal nitride nanowire may be 800 nm or less, 700 nm or less, 600 nm or less, or 500 nm or less, but is not limited thereto. The metal nitride nanowire may have a suitable long geometric shape having an aspect ratio of at least two.

According to the embodiment of the present disclosure, a thickness of the iridium oxide layer is 10 nm to 50 nm. More specifically, the thickness of the iridium oxide layer may be 10 nm or more, 15 nm or more, 20 nm or more, 25 nm or more, 30 nm or more, 35 nm or more; and the thickness of the iridium oxide layer may be 50 nm or less, 45 nm or less, 40 nm or less, or 35 nm or less, but is not limited thereto. In the related art, a catalyst layer was formed on a substrate using a physical coating method, for example, a method such as decal, brush printing, screen printing, and spray, in particular, the spray method. In this case, there is a problem in that an excessive amount of noble metal catalyst is used, thereby resulting in a large amount of loss of the noble metal catalyst. In contrast, the present inventors used the electrodeposition method in consideration of an electrochemical activity when forming the catalyst layer of the anodic electrode, and more specifically prepared the anodic electrode by electrodepositing the iridium oxide layer. Therefore, the anodic electrode that exhibits excellent performance while lowering the loading amount of the iridium oxide layer was developed. Specifically, it is possible to coat the anodic electrode of the present disclosure with the nanometer-level thin catalyst layer using the electrodeposition by electrochemical reaction rather than physical coating, thereby contributing to a decrease in contact resistance. Therefore, a loss of catalytic active area is reduced, and high catalytic activity may be obtained with a small catalyst loading amount, and the catalyst loading amount may be easily controlled according to conditions of the deposition.

According to the embodiment of the present disclosure, the metal nitride includes one or more nitride selected from a group consisting of magnesium (Mg), scandium (Sc), titanium (Ti), vanadium (V), chromium (Cr), manganese (Mn), iron (Fe), cobalt (Co), nickel (Ni), copper (Cu), zinc (Zn), and lead (Pb). The metal nitride is an earth abundant metal-based nitride. The term ‘earth abundant metal’ generally refers to a first-row transition metal which is a catalytically active and non-noble metal such as Mg as well as Sc, Ti, V, Cr, Mn, Fe, Co, Ni, Cu, and Zn. In some embodiments, the term may further refer to a base metal such as Fe, Co, Ni, Cu, Zn and Pb. In particular, in some embodiments, the term ‘earth abundant metal’ may refer to one or more of Fe, Co, Cr, Ni, Cu, Mn, and Mg. By using the earth abundant metals, the platinum layer may be replaced with cheaper metals and a utilization of iridium catalyst may be increased.

According to the embodiment of the present disclosure, a weight of the iridium oxide layer per unit area of the anodic electrode is 0.2 mg/cm² or less. More specifically, the weight of the iridium oxide layer per unit area of the anodic electrode may be 0.01 mg/cm² or more, 0.02 mg/cm² or more, 0.03 mg/cm² or more, 0.036 mg/cm² or more, 0.04 mg/cm² or more, 0.05 mg/cm² or more, 0.06 mg/cm² or more, 0.07 mg/cm² or more, 0.08 mg/cm² or more, 0.09 mg/cm² or more, 0.1 mg/cm² or more; 0.2 mg/cm² or less, 0.19 mg/cm² or less, 0.18 mg/cm² or less, 0.17 mg/cm² or less, 0.165 mg/cm² or less, 0.16 mg/cm² or less, 0.15 mg/cm² or less, 0.14 mg/cm² or less, 0.13 mg/cm² or less, 0.12 mg/cm² or less, 0.11 mg/cm² or less, 0.1 mg/cm² or less, but is not limited thereto.

According to the embodiment of the present disclosure, the substrate is titanium paper composed of titanium fibers. Previously reported electrodes use carbon material as the substrate and have a carbon corrosion problem. However, electrodes in the present disclosure use titanium as the substrate, thereby increasing stability of the electrodes.

### Water Electrolysis Device

In one aspect, exemplary embodiments of the present disclosure provide a water electrolysis device including the anodic electrode. The exemplary embodiments of the present disclosure may provide a polymer electrolyte membrane water electrolysis (PEMWE) device including the anodic electrode.

### Method of Preparing Anodic Electrode

In one aspect, exemplary embodiments of the present disclosure provide a method of preparing the anodic electrode, the method including: forming a metal oxide layer including metal oxide nanowires on a substrate; forming a metal nitride layer including metal nitride nanowires by nitriding the metal oxide nanowires; and forming an iridium oxide layer on the metal nitride layer by an electrodeposition.

Methods of forming a catalyst may be largely classified into a method of depositing a catalyst on a membrane and a method of depositing a catalyst on a PTL. The method of depositing a catalyst on a membrane is called a catalyst coated membrane (CCM) method, and the catalyst is directly deposited on an electrolyte membrane using various methods such as a spray coating, a slot die coating, an inkjet printing, and a decal transferring. The method of depositing a catalyst on a PTL is a method of directly depositing the catalyst on the PTL, which transfers electrons from a current collector to a catalyst layer and promotes mass transport of reactants and products to the catalyst layer. In the present disclosure, the CCM method was used in a controlled manner to improve catalyst utilization by minimizing loss by directly placing the catalyst on a Ti PTL.

According to the embodiment of the present disclosure, the forming of the metal oxide layer including the metal oxide nanowires on the substrate is performed by a hydrothermal synthesis. There are two main methods for synthesizing nanowires: vapor phase and solution. The vapor phase method includes a chemical vapor deposition (CVD) method, a carbothermal reduction method, and the like. However, these methods require a high synthesis temperature to obtain high-quality nanowires, or have many limitations such as reaction time, expensive vacuum equipment, and use of harmful gases. Alternatively, the method of forming nanowires through a chemical reaction in a solution is easy to use at low temperatures and mass production, and thus researches are being conducted. Among crystal growth methods using chemical reactions occurring in a solution, the hydrothermal synthesis has the advantage of growing crystals at a relatively low temperature and enabling mass production.

According to the embodiment of the present disclosure, prior to the forming of the iridium oxide layer on the metal nitride layer by the electrodeposition, a plasma etching using one or more gases selected from a group including argon, oxygen, hydrogen, helium, carbon, sulfur, fluorine and nitrogen gases is further included. The surface of the metal nitride nanowire may be partially oxidized by oxygen in the air to form a native oxide layer, and the native oxide layer is removed through the plasma etching.

According to one embodiment of the present disclosure, the metal oxide includes one or more oxides selected from a group consisting of magnesium (Mg), scandium (Sc), titanium (Ti), vanadium (V), chromium (Cr), manganese (Mn), iron (Fe), cobalt (Co), nickel (Ni), copper (Cu), zinc (Zn), and lead (Pb).

According to the embodiment of the present disclosure, nitriding the metal oxide nanowires is performed by exposing the metal oxide nanowires to gaseous ammonia at a temperature of 100° C. or more and less than 550° C. The nitriding is substituting an oxygen atom constituting the metal oxide with a nitrogen atom. More specifically, the nitriding temperature may be 100° C. or more, 150° C. or more, 200° C. or more, 250° C. or more, 300° C. or more, 350° C. or more, 400° C. or more, 450° C. or more; less than 550° C., less than 500° C., or less than 450° C., but is not limited thereto.

According to the embodiment of the present disclosure, the forming of the iridium oxide layer by electrodeposition is performed by DC plating applying DC power with a constant voltage. The DC plating may be performed under a voltage of 0.5 V_{SCE} to 1 V_{SCE}. More specifically, the DC plating voltage may be 0.5 V_{SCE} or more, 0.6 V_{SCE} or more, 0.7 V_{SCE} or more; 1 V_{SCE} or less, 0.9 V_{SCE} or less, 0.8 V_{SCE} or less, 0.7 V_{SCE} or less, but is not limited thereto.

According to the embodiment of the present disclosure, time for forming the iridium oxide layer by the electrodeposition is 10 minutes or less. More specifically, the electrodeposition time may be 1 minute or more, 2 minutes or more; 10 minutes or less, 9 minutes or less, 8 minutes or less, 7 minutes or less, 6 minutes or less, 5 minutes or less, 4 minutes or less, 3 minutes or less, 2 minutes or less, but is not limited thereto.

### EXAMPLES

Hereinafter, the present disclosure will be described in detail by examples. However, the following examples are only examples to help the overall understanding of the present disclosure, and the content of the present disclosure is not limited to the following examples.

### <Preparation Example 1> Preparation of Anodic Electrode

### 1. Deposition of Metal Oxide Layer

A porous titanium transport layer (Ti PTL, Bekaert 2GDL9N-025, porosity 60%, 250 um) substrate was cut into a size of 2×3 cm², and one side of the substrate was passivated with polyimide tape to prevent growth of iron oxide on a side of electrical contact with a bipolar plate. An aqueous solution of 60 ml consisting of 3 mmol of ferric chloride hexahydrate (FeCl₃·6H₂O) and 3 mmol of sodium sulfate (Na₂SO₄) was placed in a 100 ml Teflon-lined stainless steel hydrothermal reactor. The substrate was placed on the Teflon liner at a predetermined angle with a surface of interest facing down. The Teflon liner was sealed in a stainless steel autoclave reactor. The autoclave was placed in a furnace and heated at 120° C. for 8 hours. After the hydrothermal reaction, the substrate was thoroughly washed with deionized water and dried in a drying oven at 70° C. Accordingly, the metal oxide layer including the metal oxide nanowires was deposited on the Ti PTL.

### 2. Nitration of Metal Oxide

The substrate on which the metal oxide layer was deposited was transferred to a tube furnace. The tube furnace was vacuum purged and filled with ammonia (NH₃) gas. Subsequently, the furnace was heated to 450° C. at a ramp rate of 2.5° C./min and temperature was held at 450° C. for 3 hours at a flow rate of 200 sccm of ammonia. After the nitration reaction through annealing of the metal oxide, the tube furnace was cooled to room temperature and Ar gas was purged to remove ammonia, and then the substrate was collected.

### 3. Electrodeposition of Iridium Oxide Layer

0.133 g of iridium chloride hydrate (K₃IrCl₆) and 0.2 g of oxalic acid dihydrate (C₂H₂O₄·2H₂O) was dissolved in 35 ml of deionized water. Subsequently, 0.4 ml of a 30% hydrogen peroxide (H₂O₂) aqueous solution was added dropwise to the iridium solution, and then 2.21 g (16 mmol) of potassium carbonate dissolved in 5 ml of deionized water was added dropwise. An electrodeposition bath solution includes stable iridium oxide colloids formed by mixing IrCl₄, H₂O₂, oxalates and carbonates in an aqueous solvent. An iridium oxide (IrO₂) deposition solution was prepared by stirring the prepared solution in a water bath at 30° C. for 4 days until the prepared solution turned dark blue. Subsequently, the iridium oxide layer was deposited with 0.7 V_{SCE} on the metal nitride (Fe₂N) layer. Deposition time was adjusted to 1 minute, 3 minutes, 5 minutes and 10 minutes.

### <Referential Example 1> Deposition of Iridium Oxide Layer on Metal Oxide Other than Metal Nitride

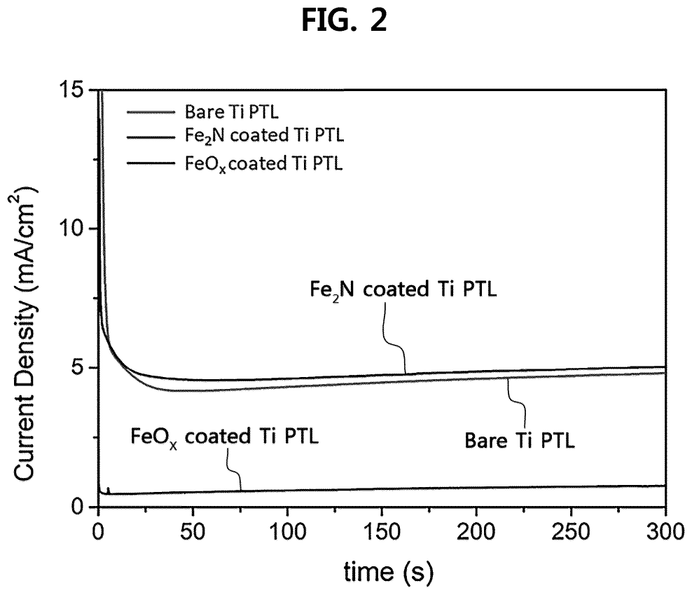

FIG. 2 illustrate time-current data for the electrochemical deposition of the iridium oxide layer. Referring to FIG. 2, it may be confirmed that when the iridium oxide layer is deposited on the metal oxide rather than the metal nitride, electrodeposition is not practical due to an insignificant deposition current detected at an insulating metal oxide electrode. However, the iridium oxide was apparently deposited on Ti fiber and a surface of Ti fiber deposited with the metal nitride, and the electrode was colored black.

### <Referential Example 2> Preparation of Anodic Electrode for Comparative Example

An anodic electrode according to a comparative example was prepared by electrodeposition of the iridium oxide layer in the same manner as in the preparation example 1 on a porous titanium transport layer substrate on which the metal nitride (Fe₂N) layer was not deposited.

### <Preparation Example 2> Preparation of Membrane Electrode Assembly (MEA)

A membrane electrode assembly was prepared by placing a cathode and the anodic electrode prepared in the preparation example 1 on both sides of a Nafion™ 212 membrane (50 μm, DuPont). The cathode was prepared with a Pt loading of 0.2 mg/cm² by spray-coating a Pt/C catalyst (Pt 46.2 wt %, Tanaka Kikinzoku group) with a Nafion ionomer on a carbon-based gas diffusion layer (39 BC, SGL group, thickness: 325±25 μm, 5% PTFE). More specifically, hot pressing was performed at 120° C. for 1 minute at a pressure of 2.7 Mpa, and a cell was fastened with 80 lb·in to prepare a sandwich structure membrane electrode assembly (2.25 cm²).

### <Experimental Example 1> Observation of Structure of Anodic Electrode Catalyst

### 1. Method of Evaluation

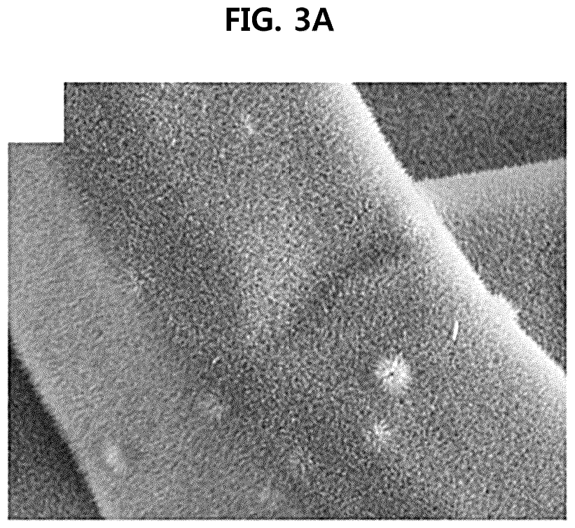

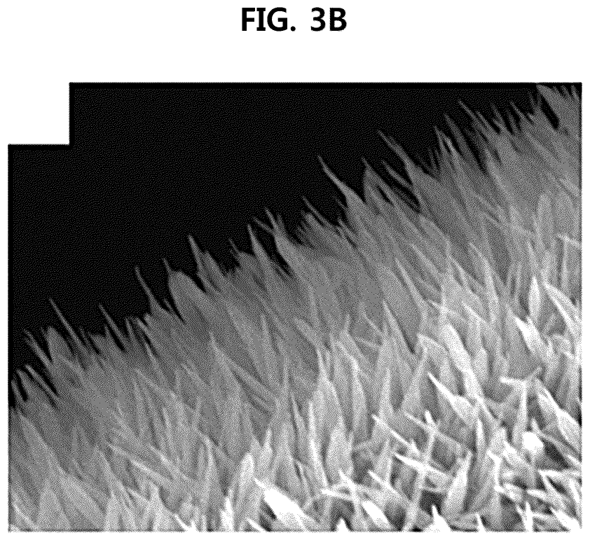

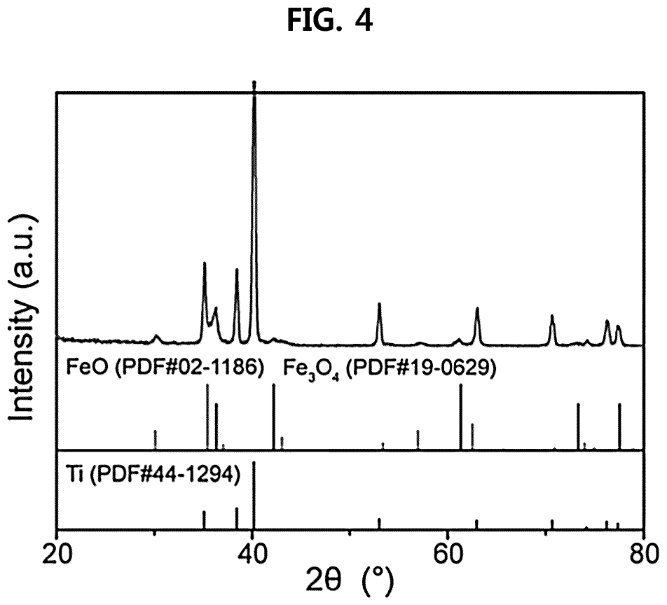

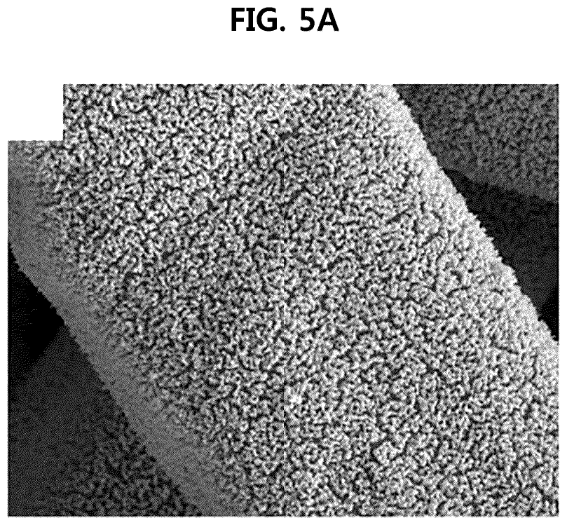

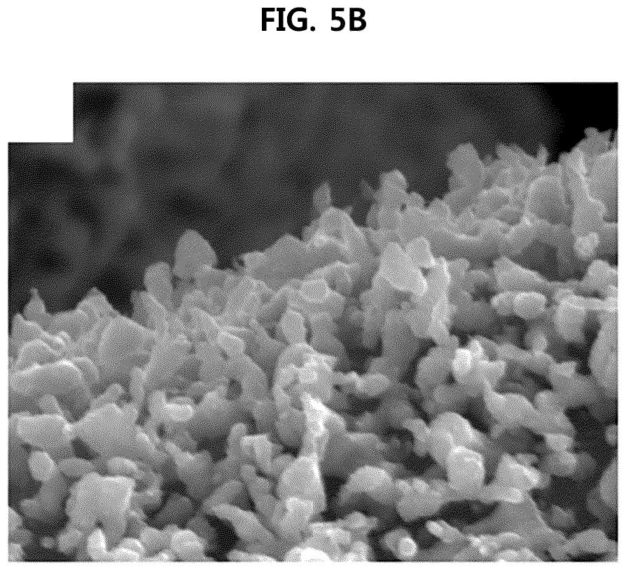

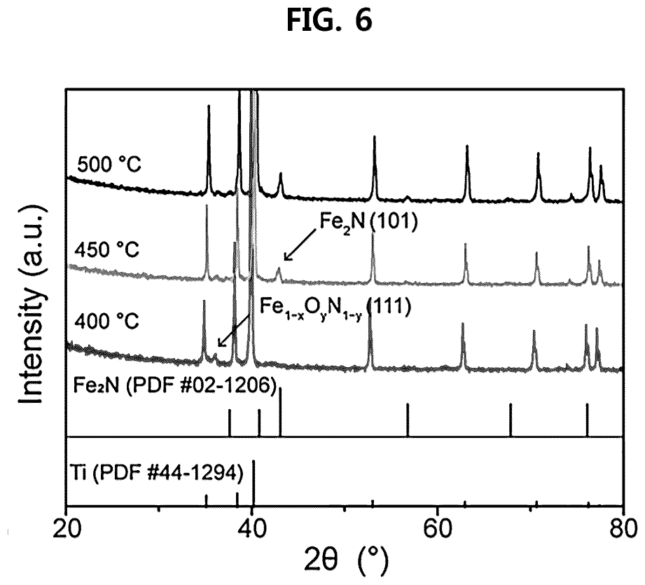

A morphology of the catalyst formed on the substrate was observed using a scanning electron microscope (SEM, Teneo VS, Field emission Inc.). SEM images are illustrated in FIGS. 3A, 3B and 5A and 5B. FIGS. 3A, 3B and 5A and 5B are SEM images illustrating morphologies of the anodic electrode catalyst according to the embodiment of the present disclosure. XRD (X-ray Diffraction) spectrum of the catalyst formed on the substrate was observed using an X-ray diffractometer (D8 advance, Bruker). Results are illustrated in FIGS. 4 and 6. FIGS. 4 and 6 are images illustrating the XRD spectrum of the anodic electrode catalyst according to the embodiment of the present disclosure.

### 2. Observation of Structure of Metal Oxide Catalyst

Referring to FIGS. 3A and 3B, it may be confirmed that iron oxide nanowires having a width of about 40 to 80 nm and a length of about 400 to 600 nm were uniformly deposited on the surface of the Ti fiber by the hydrothermal reaction. Referring to FIG. 4, it may be confirmed that the iron oxide nanowires are consisted of a FeO Wustite structure and a Fe₃O₄ magnetite structure. However, it may be assumed that Ti PTL-decorated iron oxide nanowires are not suitable for water electrolysis with large operating current density due to low electrical conductivity of oxide materials. Accordingly, the iron oxide is converted to iron nitride to improve electrical conductivity.

### 3. Observation of Structure of Metal Nitride Catalyst

Referring to FIGS. 5A and 5B, it may be confirmed that morphology of iron oxide changes as a nitration reaction occurs. After nitriding at 400° C., the iron oxide nanowires with straight needle-like shapes aggregated into round particles. Meanwhile, it was also confirmed that a color of the yellow iron oxide film changed to black, and a successful phase transition from iron oxide to iron nitride occurred at 450° C. Referring to FIG. 6, it may be confirmed that as the nitriding temperature increases to 450° C., a peak around 36.0° disappears, and a peak positioned at 43.0° corresponding to the (101) plane of Fe₂N (PDF #02-1206) appears, indicating complete conversion from oxide to nitride. When nitrided with metal nitride, the XRD peak indicates a decrease of Fe₃O₄, and a (111) peak of Wustite Fe₁₋ₓO shifted from 36.3° to 36.0°. The weak reflection at 36.0° is indicated by the (111) peak of the Wustite-like iron oxynitride (Fe₁₋ₓO_{y}N_{1-y}), indicating that partial nitrification of the iron oxide has occurred. When the nitriding temperature increased to 500° C., XRD peaks developed more distinctly at 56.8° and 67.9° corresponding to (102) and (110) planes of Fe₂N, indicating that crystallinity of the Fe₂N phase increased.

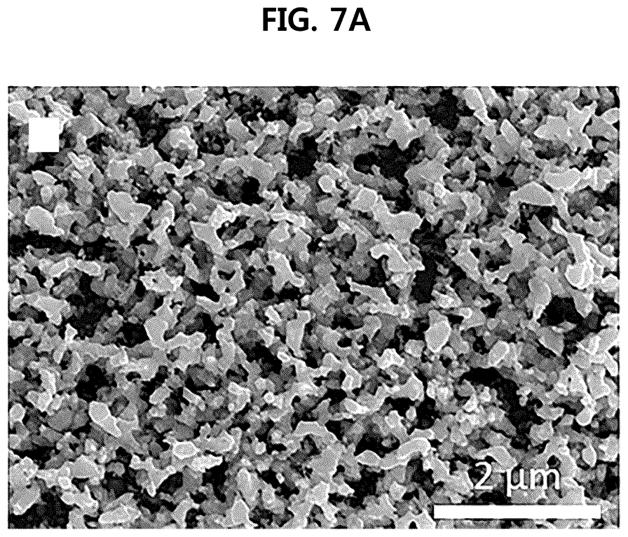

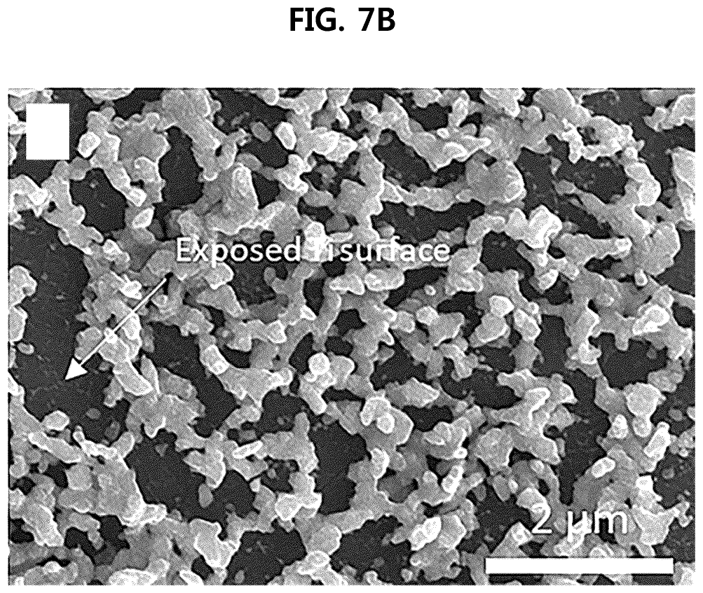

Meanwhile, referring to FIGS. 7A and 7B, it may be confirmed that aggregation of Fe₂N particles is further increased when the nitriding temperature is 550° C. (right side) compared to when the nitriding temperature is 500° C. (left side). FIGS. 7A and 7B are SEM images illustrating the morphologies of the anodic electrode catalyst according to the embodiment of the present disclosure. Since severe aggregation of the particles reduces a specific surface area of the electrode, it is required to set an appropriate nitration temperature to preserve a large surface area of the Fe₂N core, which serves as an effective support body for an active water oxidation catalyst, which is iridium oxide. In this experiment, the nitriding temperature was fixed at 450° C.

### <Experimental Example 2> Measurement of Electrical Resistance of Anodic Electrode Catalyst

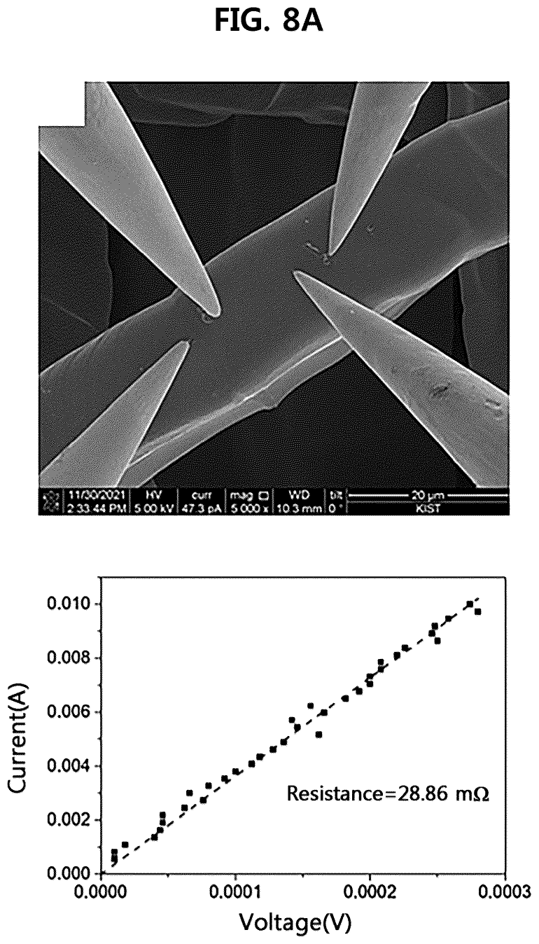

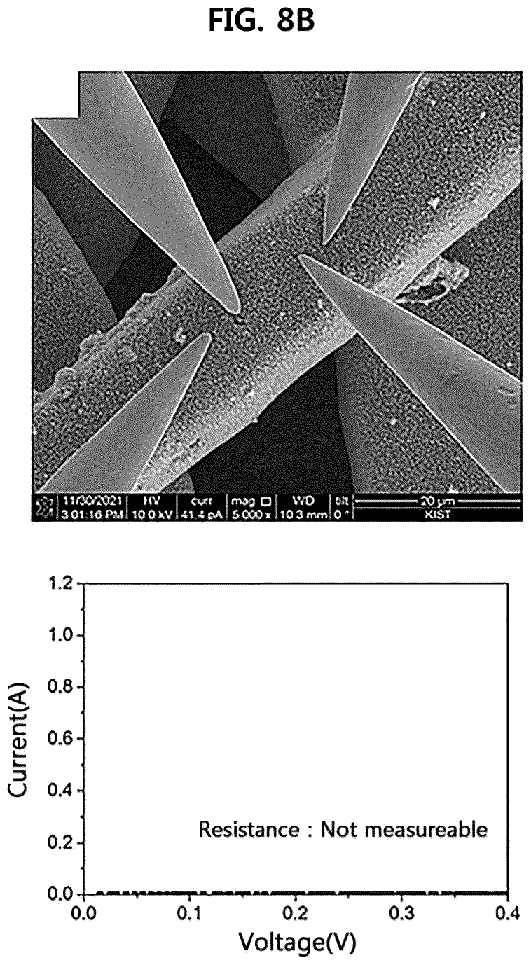

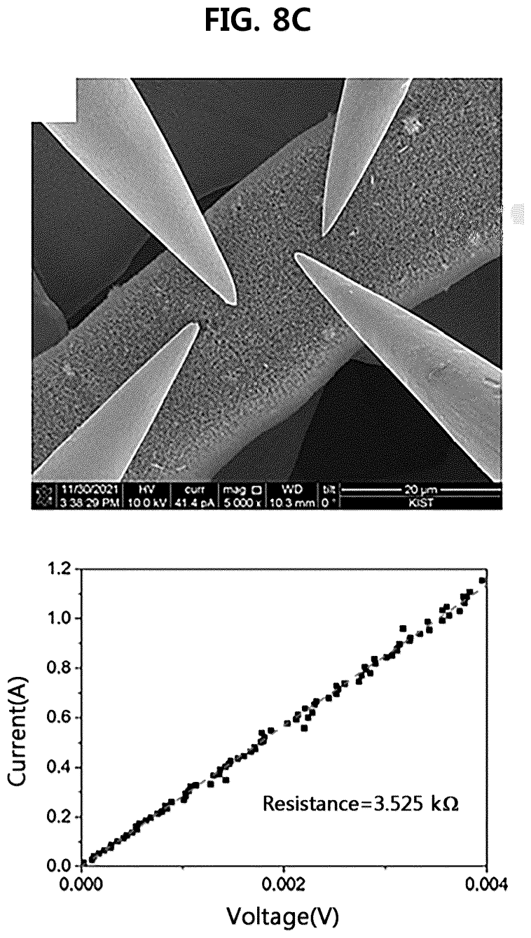

Electrical resistance was measured for each of the Ti fiber, Ti fiber deposited with metal oxide, and Ti fiber deposited with metal nitride. The electrical resistance was measured using an SEM (FIB, FEI Company Quanta 3D) equipped with four nanomanipulators (Klindiek, MM3A EM). SEM images and electrical resistance are illustrated in FIGS. 8A to 8C. FIGS. 8A to 8C are SEM images illustrating morphologies of the anodic electrode catalyst according to the embodiment of the present disclosure and a graph illustrating electrical resistance.

Referring to FIGS. 8A to 8C, in case of the Ti fiber on which no metal is deposited, electronic resistance between two tungsten tips 10 μm apart was measured to be 28.86 mΩ. With an approximate diameter of the Ti fiber being 20 μm, resistivity of Ti PTL was calculated as 9.0×10⁻⁷ Ωm. A difference in resistivity between the resistivity of the Ti fiber obtained by four-point probe measurement and the reported resistivity of bulk Ti (4.2-4.7×10⁻⁷ Ωm) is less than ten times. This means that almost no native oxide is generated on a surface of the Ti fiber, and resistance of each fiber may be estimated through the four-point probe measurement. In addition, when the four-point probe measurement was attempted with the Ti fiber deposited with metal oxide, resistance exceeded a detection limit of an analyzer, and an insulating metal oxide layer prevented actual current flow on the Ti fiber surface. However, after nitriding treatment, resistance of the surface layer decreased and was measured as 3.525 kΩ. This resistance value corresponds to a significantly lower value than the previously reported electrical resistance value of 474 kΩ for the Ti fiber coated with an iridium oxide layer. Accordingly, it may be confirmed that the metal nitride layer is capable of being an effective catalyst support body that provides active surface area expansion and catalyst utilization improvement.

### <Experimental Example 3> Composition Measurement of Anodic Electrode Catalyst

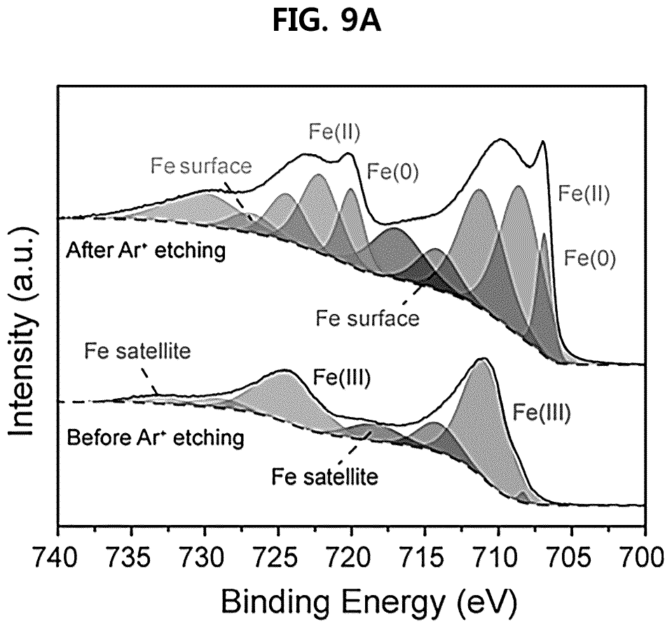

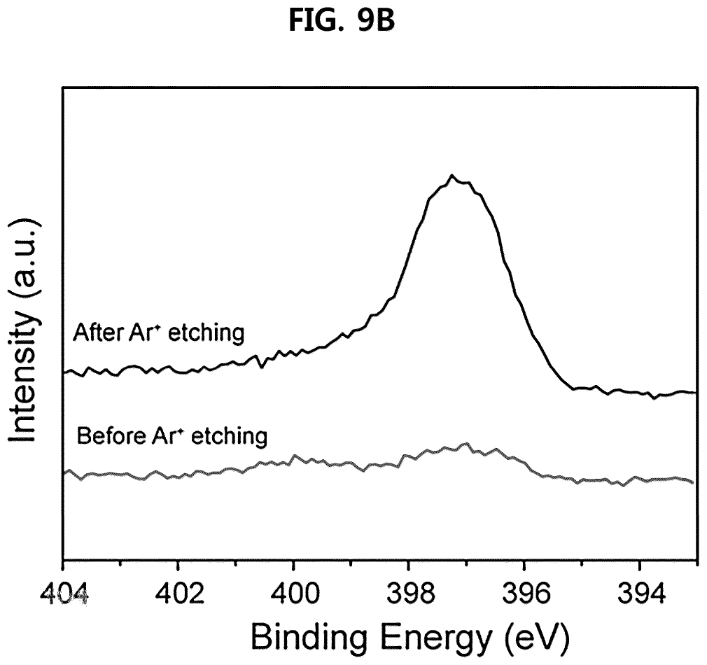

Composition of the catalyst formed on the substrate was investigated by X-ray photoelectron spectroscopy (K-alpha, Thermo Scientific) using Al K (1486.6 eV) radiation. Results are illustrated in FIGS. 9A and 9B. FIGS. 9A and 9B are XPS images illustrating the composition of the anodic electrode catalyst according to the embodiment of the present disclosure. The obtained XPS spectrum was measured by correcting a C—C peak position of C1s peak of adventitious carbon to 284.8 eV.

Referring to FIGS. 9A and 9B, it may be confirmed that Fe 2p XPS spectrum of metal nitride is mainly composed of Fe(III) species, as indicated by Fe 2p_{3/2} and Fe 2p_{1/2} peaks at 711.2 and 724.7 eV, respectively. A high-BE surface peak was used to fit an asymmetric peak of Fe 2p, and peaks at 718.5 and 733.3 eV were assigned to Fe satellite peaks. The results indicate that the surface of Fe₂N was partially oxidized by atmospheric oxygen after the nitriding process. However, a thin native oxide layer of Fe₂N may be simply removed by irradiation with argon ions (Art), XPS peaks corresponding to Fe(0) at 706.8 and 720.0 eV and Fe(II) at 708.6 and 722.3 eV appear after the ion etching reaction is applied. N 1s XPS spectrum of Fe₂N at 397.3-397.6 eV also indicates that N 1s signal increases after the ion etching process after removing the surface native oxide. As a result of the analysis, binding energy of metal nitride appeared indicating that Fe₂N was successfully formed through the nitriding treatment of the metal oxide.

### <Experimental Example 4> Observation of Anodic Electrode Surface Morphology

### 1. Method of Evaluation

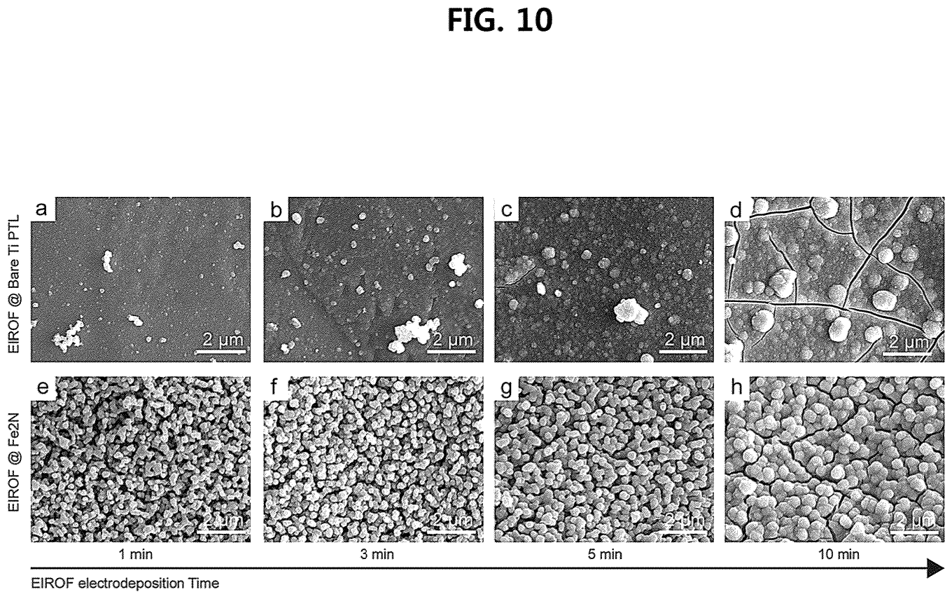

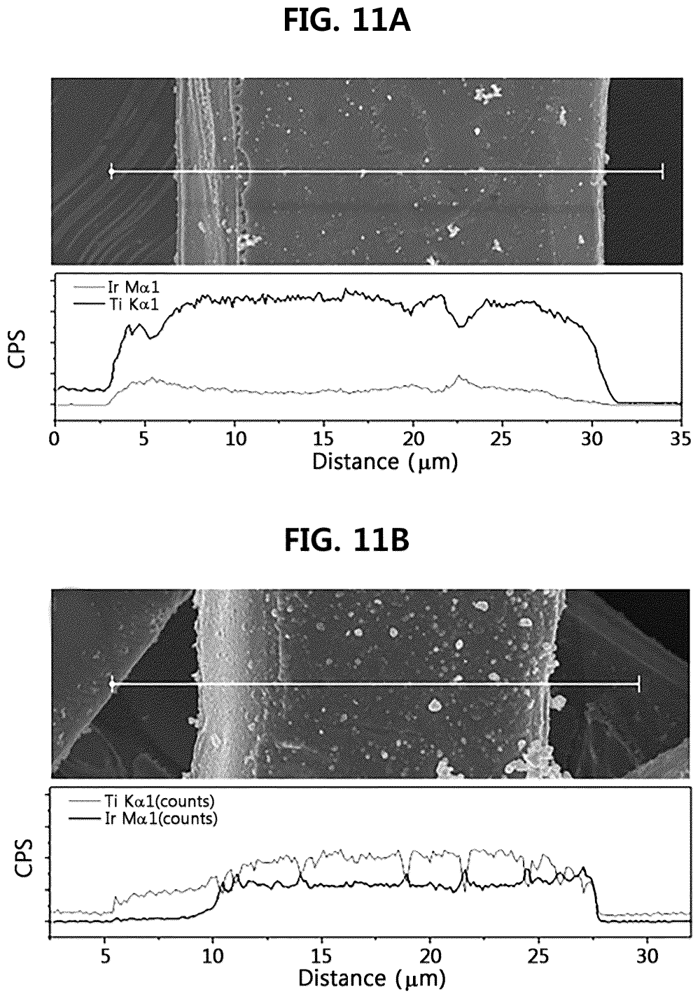

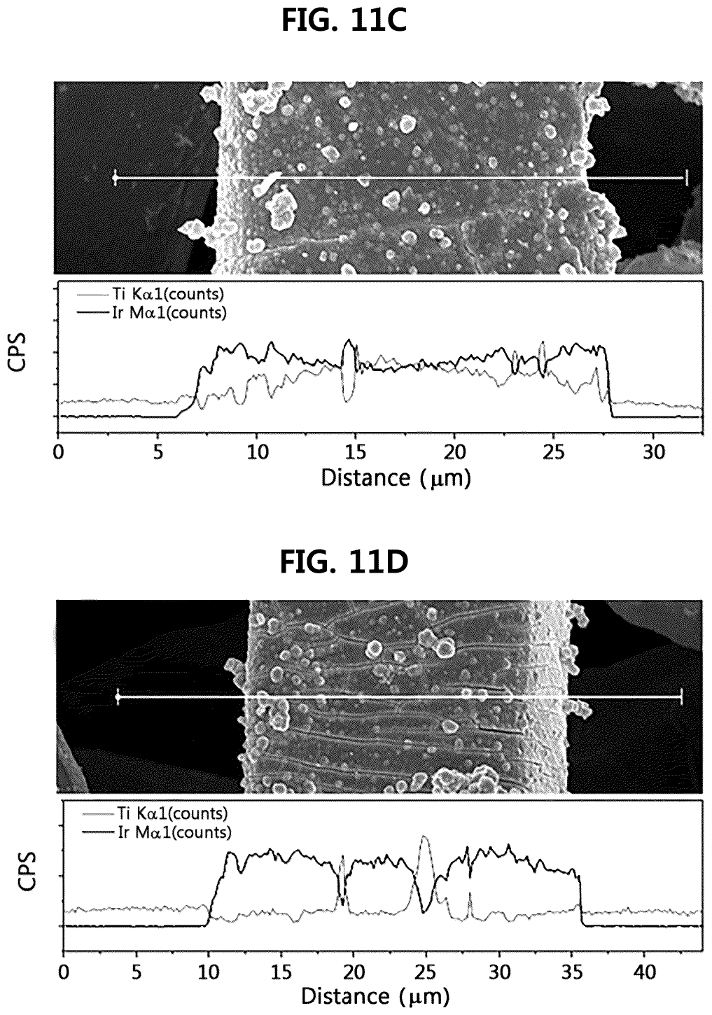

Surface morphology of the anodic electrode according to the embodiment of the present disclosure was observed using a scanning electron microscope (SEM, Teneo VS, Field emission Inc.). SEM images are illustrated in FIG. 10. FIG. 10 is SEM images illustrated the surface morphology of the anodic electrode according to the embodiment of the present disclosure. Energy Dispersive Spectrometer (EDS) line scanning analysis was performed with a high-resolution SEM (Regulus 8230, Hitachi) equipped with a super EDS (Ultim Max, Oxford). EDS images are illustrated in FIGS. 11A to 11D. FIGS. 11A to 11D are images illustrating line scanning analysis results of the anodic electrode according to the embodiment of the present disclosure (FIGS. 11A to 11D illustrate cases in which deposition time is 1 minute, 3 minutes, 5 minutes, and 10 minutes, respectively).

### 2. Iridium Oxide Layer Deposited on Ti Fiber

When the deposition time (t_{dep}) was 1 minute, a thin layer of iridium oxide containing non-uniformly deposited spherical iridium particles covered the Ti fiber (FIG. 10A). EDS line scanning also reveals the formation of the iridium oxide layer on the Ti fiber (FIG. 11A).

As the deposition time (t_{dep}) increased to 3 and 5 minutes, the Ti fiber surface was layered by thicker iridium oxide with a roughened surface (FIGS. 10A and 10C). In addition, as the deposition time became longer and the iridium oxide layer became thicker, EDS intensity of the Ti fiber was weakened while EDS intensity of Ir was enhanced (FIGS. 11B and 11C).

As the deposition time (t_{dep}) increased to 10 minutes, thicker iridium oxide cracks were observed (FIG. 10D). It is assumed that deformation and volume changes caused by film dehydration from the electrodeposited iridium oxide layer caused cracking of the thick iridium oxide.

### 3. Iridium Oxide Layer Deposited on Metal Nitride-Deposited Ti Fiber

When the deposition time (t_{dep}) was 1 minute, the Fe₂N nanowire structure was maintained while maintaining a pore structure between the Fe₂N nanowires (FIG. 10E).

As the deposition time (t_{dep}) increased to 3 and 5 minutes, the iridium oxide uniformly grew on the Fe₂N nanowires and spacing between the Fe₂N nanowire structures was reduced (FIGS. 10F and 10G).

When the deposition time (t_{dep}) increased to 10 minutes, the thick iridium oxide layer fills nano-gaps between the Fe₂N nanowires, and cracks occurred on a surface similar to the iridium oxide layer formed on the Ti fiber, as illustrated in FIG. 10D.

### <Experimental Example 5> Measurement of Iridium Loading Amount of Anodic Electrode

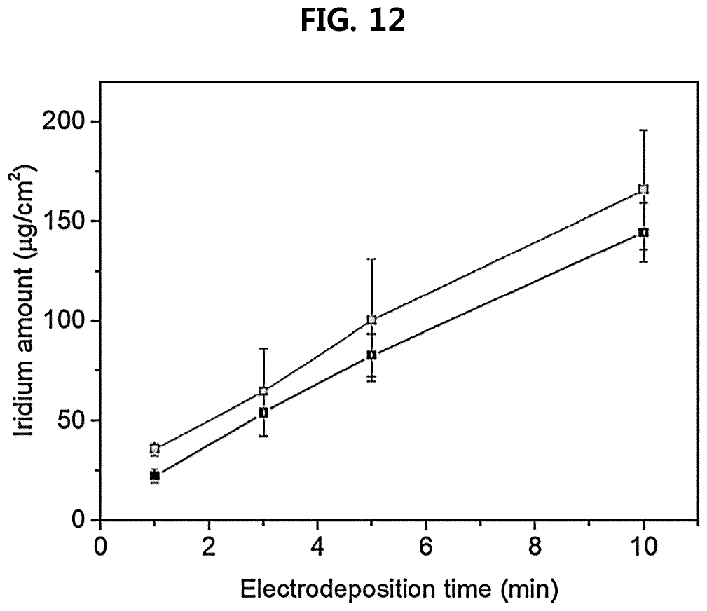

An iridium loading amount of the anodic electrode was analyzed by inductively coupled plasma-atomic emission spectrometer (ICP-AES, Optima 7300DV, PerkinElmer). Since the ICP-AES measurement requires dissolving a solid sample into a solution, iridium was dissolved by a microwave decomposition method using aqua regia. A result is illustrated in FIG. 12. FIG. 12 is an ICP-AES image illustrating the iridium loading amount of the anodic electrode according to the embodiment of the present disclosure.

Referring to FIG. 12, As the deposition time (t_{dep}) increased from 1 minute to 10 minutes, an amount of Ir in the iridium oxide layer changed from 22 to 144 μg/cm² on bare Ti fiber. As the deposition time (t_{dep}) increased from 1 minute to 10 minutes on the metal nitride-deposited Ti fiber, the amount of Ir in the iridium oxide layer varied from 36 to 165 μg/cm² on the bare Ti fiber, approximately 15-50% higher Ir loading amount was observed. Therefore, it may be confirmed that a high surface area of the Fe₂N nanowires provides more sites for electrodeposition, resulting in obtaining higher Ir loading amount.

### <Experimental Example 6> Composition Measurement of Anodic Electrode 1

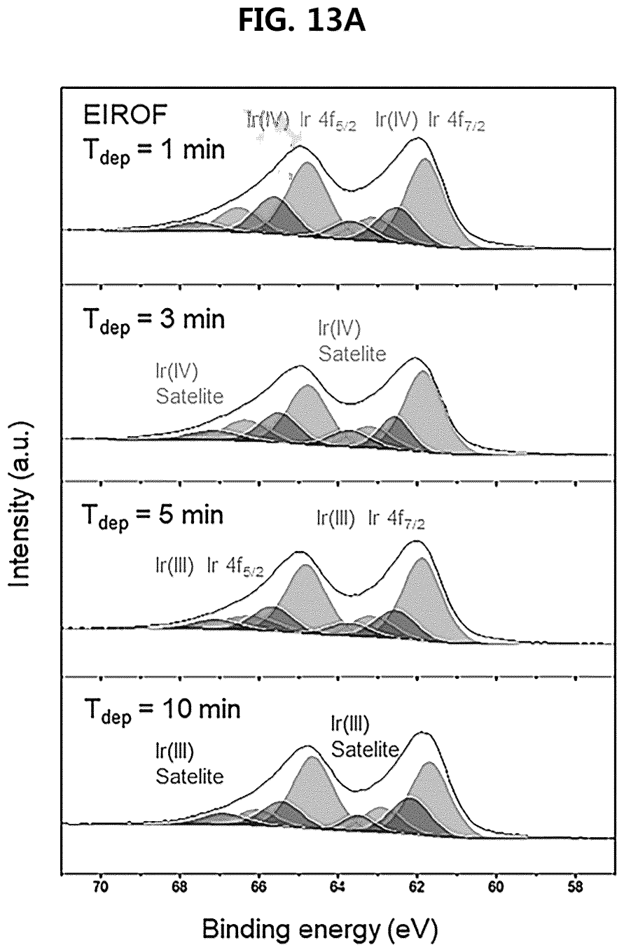

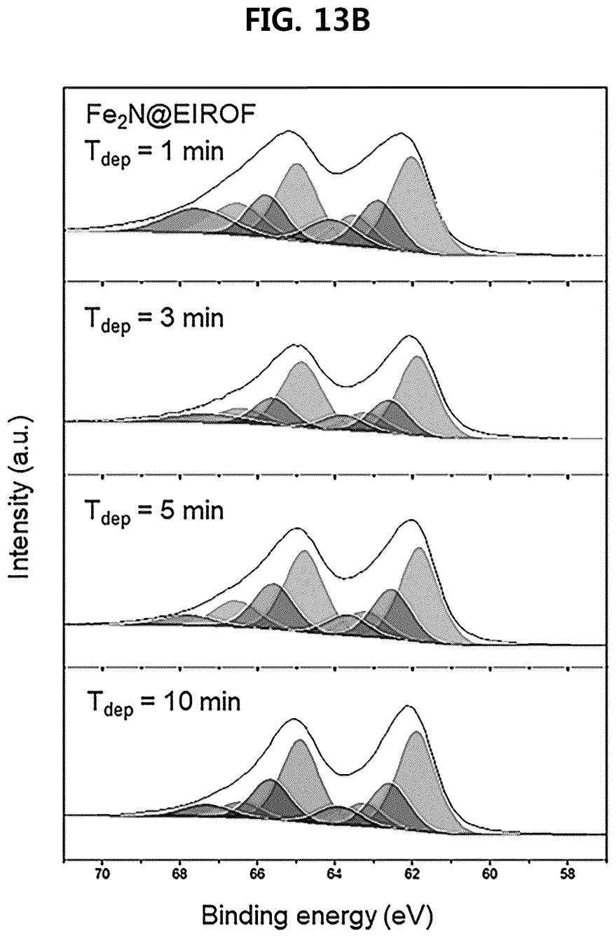

The composition of the anodic electrode was investigated by X-ray photoelectron spectroscopy (K-alpha, Thermo Scientific) using Al K (1486.6 eV) radiation. Results are illustrated in FIGS. 13A and 13B. FIGS. 13A and 13B are XPS images illustrating the composition of the anodic electrode according to the embodiment of the present disclosure. The obtained XPS spectrum was measured by correcting a C—C peak position of C1s peak of adventitious carbon to 284.8 eV.

Referring to FIGS. 13A and 13B, it may be confirmed that two asymmetric Ir 4f peaks appeared around 65.1 eV (4f_{5/2}) and 62.2 eV (4f_{7/2}). A broad peak characteristic indicates that the electrodeposited iridium oxide has a mixed Ir valence state. The peaks deconvolve into Ir(IV) peaks at 65.10 eV (4f5/2) and 62.10 eV (4f7/2), and Ir(III) peaks at 66.55 eV (4f_{5/2}) and 63.55 eV (4f_{7/2}) with each satellite peak at higher binding energy.

### <Experimental Example 7> Composition Measurement of Anodic Electrode 2

### 1. Method of Evaluation

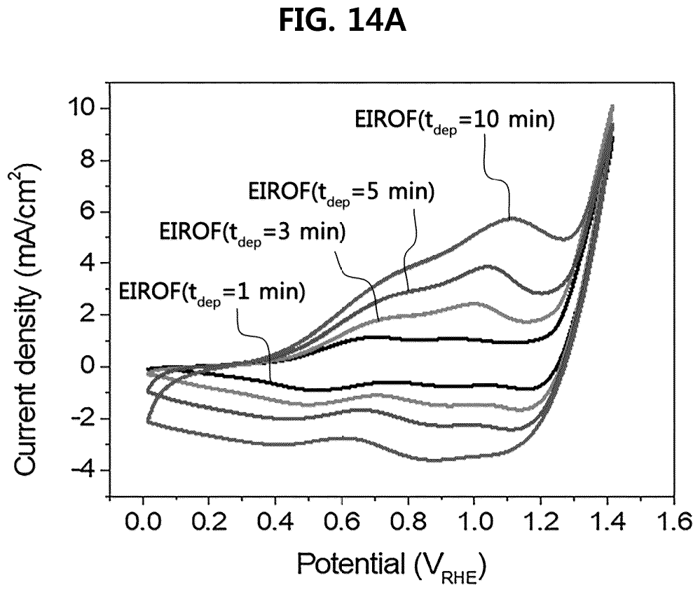

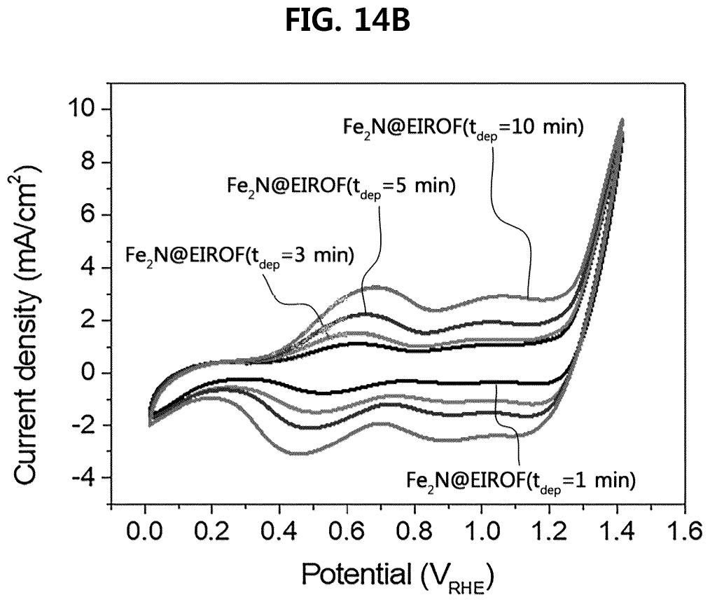

Cyclic voltammetry (CV) curves were obtained to measure the composition of the anodic electrode. FIGS. 14A and 14B are graphs illustrating cyclic voltammetry (CV) curves of the anodic electrode according to the embodiment of the present disclosure. Ir(III)/(IV) and Ir(IV)/Ir(V) redox pairs were measured from the cyclic voltammetry (CV) curves. An Ir redox transition was observed in a potential window of 0.4 to 1.2 V_{RHE} without interference of the water oxidation reaction in 0.1 M phosphate buffer pH 7.

### 2. Evaluation Results

Referring to FIGS. 14A and 14B, peaks at about 0.8 and 1.2 V_{RHE} correspond to Ir(III)/(IV) and Ir(IV)/(V) of iridium oxide formed on the substrate. In addition, redox currents for Ir(III)/(IV) and Ir(IV)/(V), which increased with the increasing deposition time(t_{dep}), clearly indicates that an amount of active iridium species increases with the longer deposition time(t_{dep}).

Intensity of Ir(III)/(IV) and Ir(IV)/(V) redox peaks and dependence thereof on the deposition time(t_{dep}) were different in the Ti fiber and the metal nitride-deposited Ti fiber. In case of the iridium oxide layer on the Ti fiber, the peak of Ir(IV)/(V) increased more distinctly than that of Ir(III)/(IV) according to the deposition time (t_{dep}). However, in case of the iridium oxide layer on the metal nitride-deposited Ti fiber, the peak currents of both Ir(III)/(IV) and Ir(IV)/(V) increased steadily. In addition, the Ir(IV)/(V) peak current of the iridium oxide layer on the metal nitride-deposited Ti fiber was lower than the Ir(IV)/(V) peak current of the iridium oxide layer on the Ti fiber.

Despite using 15-50% less iridium oxide than on the metal nitride-deposited Ti fiber, a difference in redox peak tendencies indicates that the iridium oxide layer deposited on the metal nitride-deposited Ti fiber is thinner or the iridium oxide layer deposited on the metal nitride-deposited Ti fiber is more conductive.

### <Experimental Example 8> Measurement of Anodic Electrode Thickness

### 1. Method of Evaluation

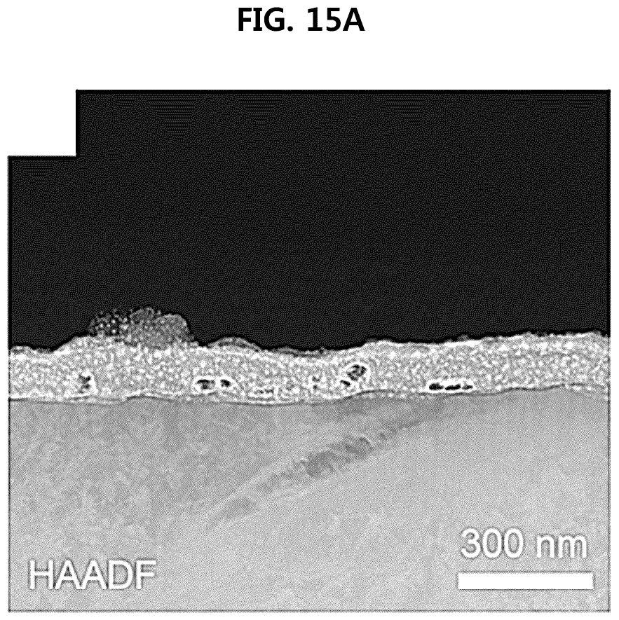

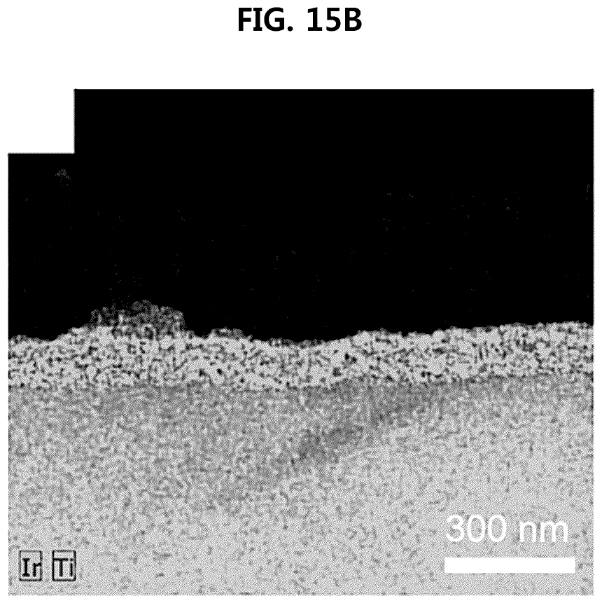

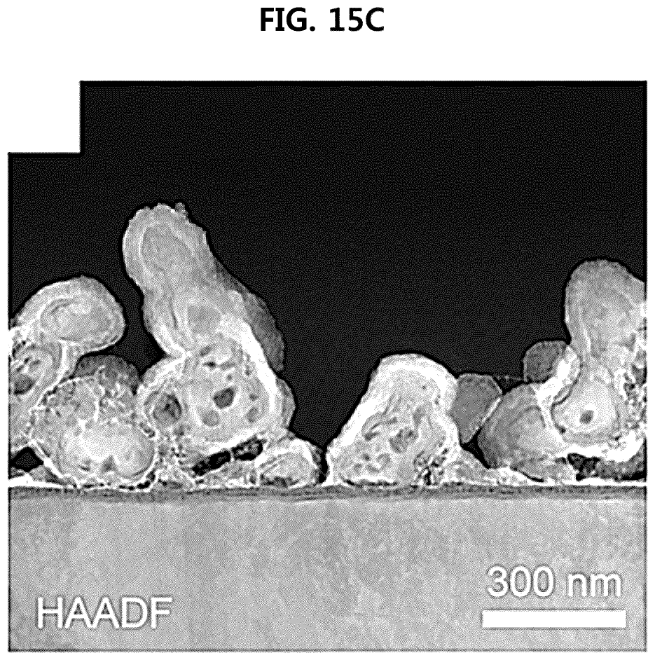

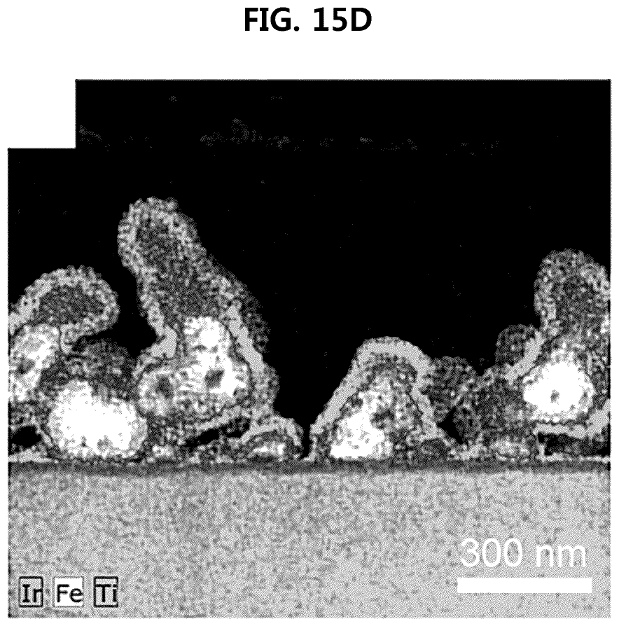

Thickness of the anodic electrode according to the embodiment of the present disclosure was measured through STEM-HAADF (scanning transmission electron microscope-high angle annular dark field imaging) and energy dispersive spectrometer (EDS) line scanning analysis. FIGS. 15A to 15D are STEM-HAADF images and EDS images of the anodic electrode according to the embodiment of the present disclosure.

Referring to FIGS. 15A to 15D, it may be confirmed that the thickness of the iridium oxide layer deposited on the Ti fiber for 5 minutes is 103±6 nm. In addition, it may be seen that the thickness of the iridium oxide layer deposited for 5 minutes on the metal nitride-deposited Ti fiber is remarkably thin as 35±5 nm. These results strongly support the smaller electrical resistance than a case without a metal nitride support body on the Ti fiber.

### <Experimental Example 9> Evaluation of Water Electrolysis Performance 1

### 1. Method of Evaluation

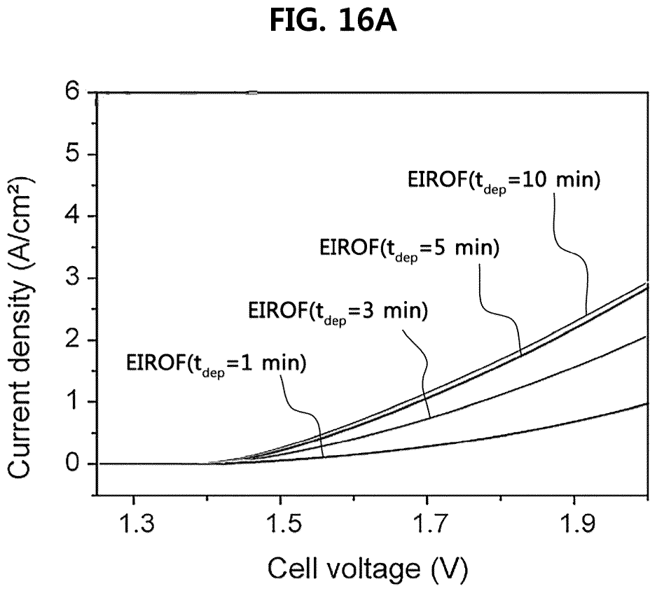

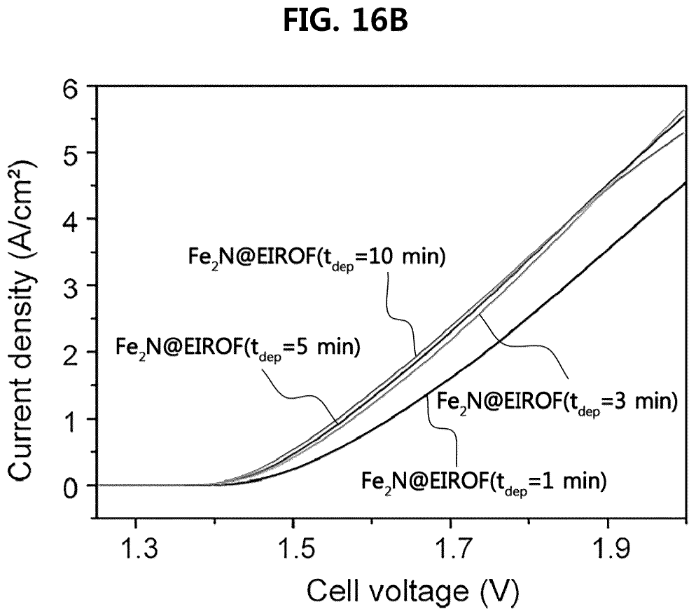

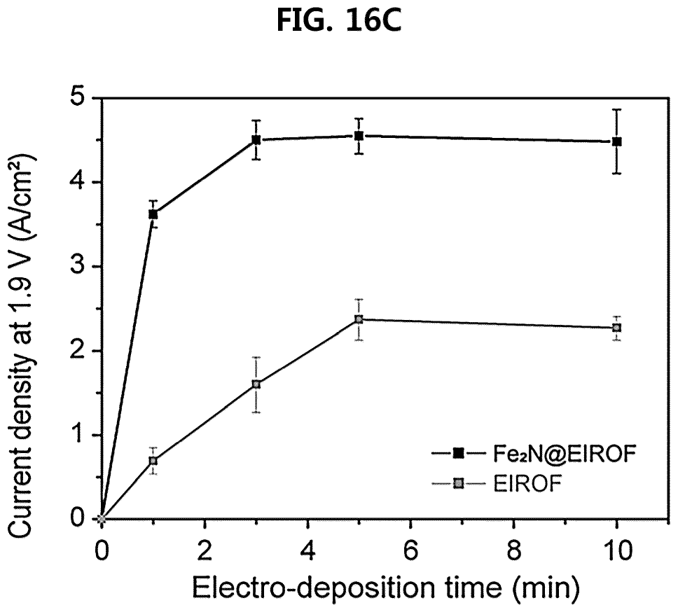

Oxygen evolution reaction (OER) activity was observed to evaluate water electrolysis performance of the membrane electrode assembly (MEA) prepared in preparation example 2. A water electrolysis cell was prepared using the membrane electrode assembly prepared in preparation example 2. Deionized water was supplied only to an anodic electrode side of the water electrolysis cell. Cell temperature was maintained at 80° C. with a flow of preheated deionized water on the anodic electrode. FIGS. 16A to 16C are graphs illustrating I-V polarization curves of a water electrolysis device including the anodic electrode according to the embodiment of the present disclosure. The I-V curves was measured with a semiconductor device analyzer (Agilent Technologies, B1500A) using the four-electrode method. Electrochemical analysis was performed using a potentiostat (HCP-803, Biologics Ltd).

### 2. Evaluation Results

In the presence of the iridium oxide layer deposited on the Ti fiber without the metal nitride nanowire structure (FIG. 16A), a gradual increase in performance of the water electrolysis cell was observed until the deposition time(t_{dep}) reached 5 minutes. More specifically, current density increased from 0.69 A/cm² (t_{dep}=1 minute) to 2.16 A/cm² (t_{dep}=5 minutes) at an applied cell voltage of 1.9 V_{cell}.

However, when the deposition time(t_{dep}) was 10 minutes, the current density reached 2.27 A/cm² at the applied cell voltage of 1.9 V_{cell}, and no additional performance improvement of the water electrolysis cell was observed, which indicates that an additional iridium oxide layer does not efficiently provide active sites for water oxidation after the deposition time(t_{dep}) reaches a predetermined time. Meanwhile, when using the anodic electrode in which the iridium oxide layer was deposited on the metal nitride-deposited Ti fiber, the performance of the water electrolysis cell was significantly improved compared to a case without the metal nitride layer (FIG. 16B).

Referring to FIG. 16C, in case of the anodic electrode in which the iridium oxide layer was deposited on the Ti fiber on which the metal nitride was deposited, current density was 3.62 A/cm² at 1.9 V_{cell} even when the deposition time(t_{dep}) was 1 minute, and the metal nitride is 5 times higher than when no metal nitride was deposited. As the deposition time(t_{dep}) increases to 3 minutes, the current density reaches 4.50 A/cm² at 1.9 V_{cell}, which is three times higher than when no metal nitride is deposited. However, when the deposition time (t_{dep}) exceeded 3 minutes, the performance of the water electrolysis cell slightly increased. At cell voltages lower than 1.8 V_{cell}, the current density increased slightly as the deposition time(t_{dep}) increased from 3 minutes to 10 minutes, and at higher voltages above 1.9 V_{cell}, the current density decreased as the deposition time(t_{dep}) increased more than 3 minutes.

### <Experimental Example 10> Evaluation of Water Electrolysis Performance 2

### 1. Method of Evaluation

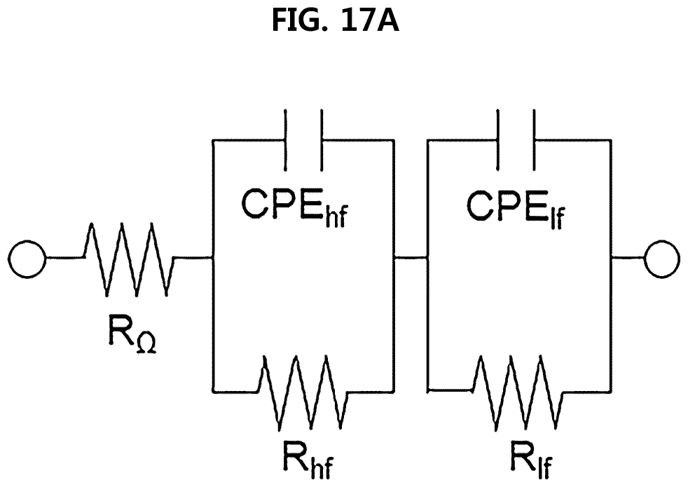

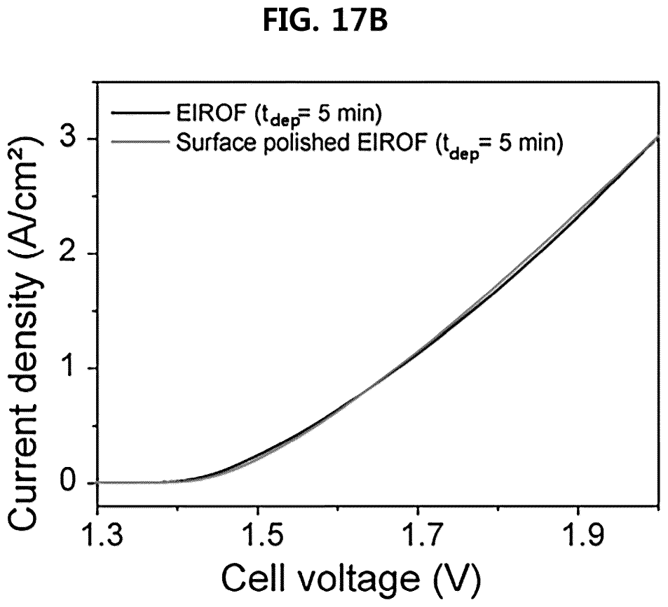

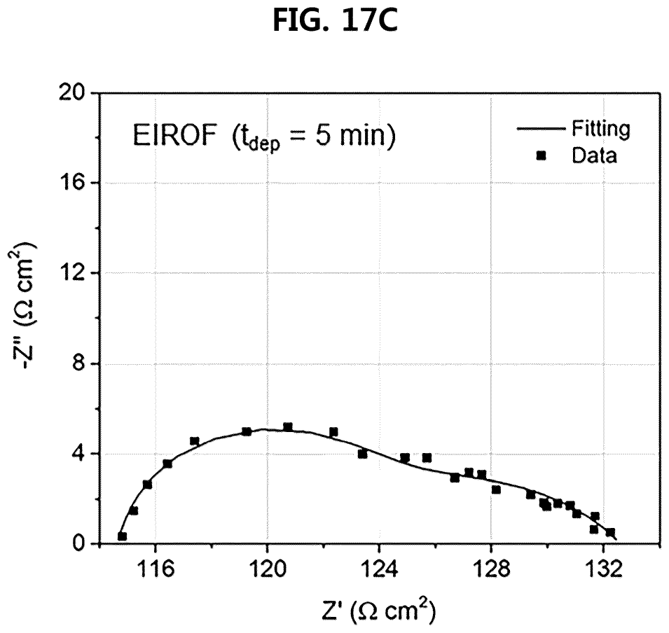

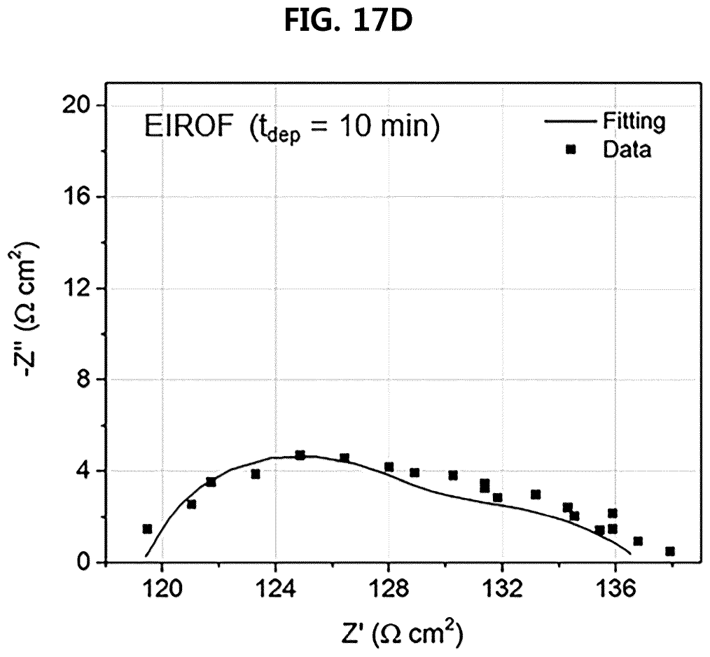

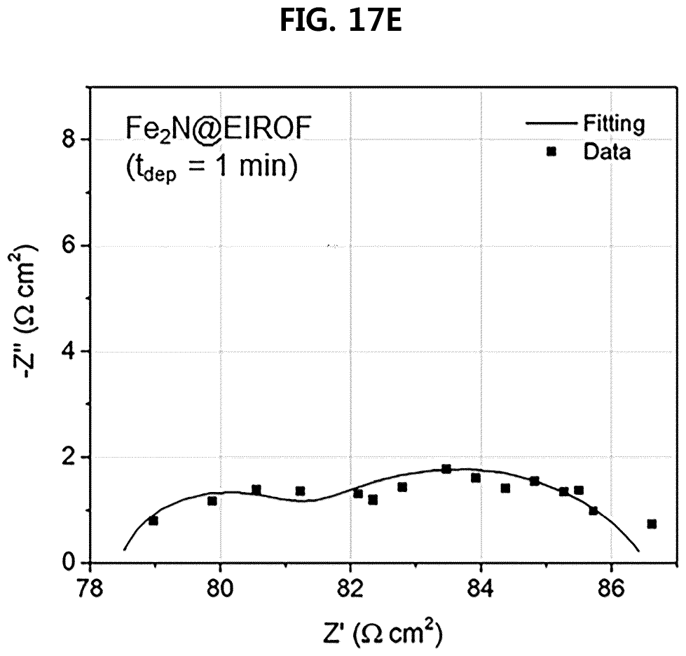

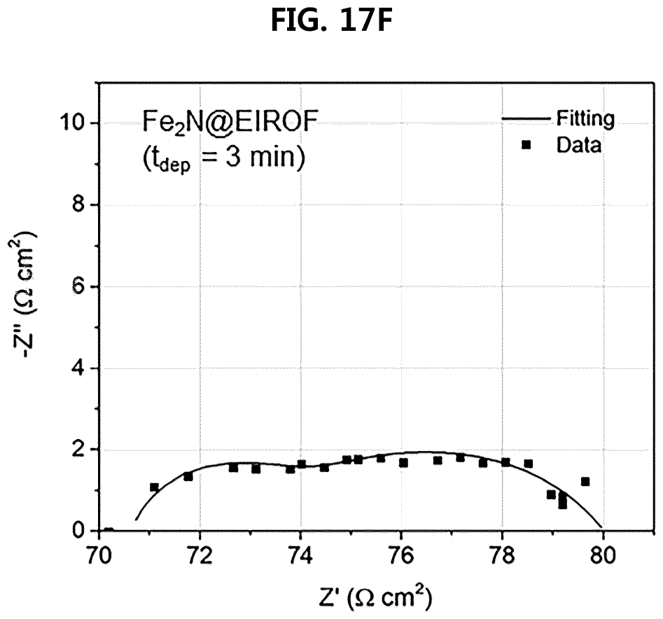

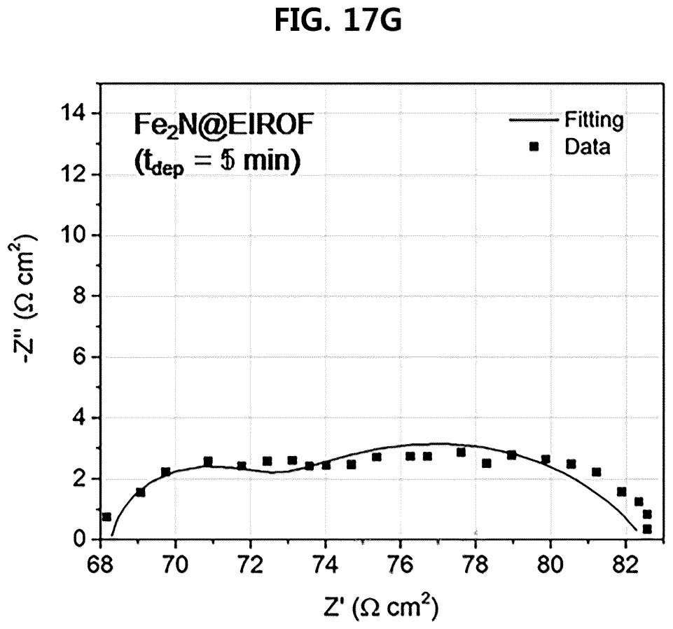

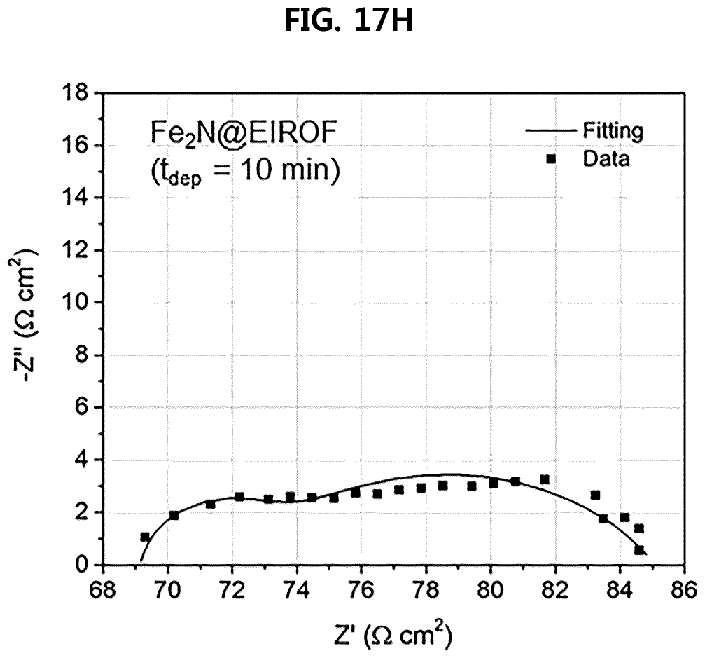

Water electrolysis performance of the water electrolysis device including the anodic electrode according to the embodiment of the present disclosure was evaluated using electrochemical impedance spectroscopy (EIS). FIGS. 17A to 17H are graphs illustrating Nyquist plots, which are measurement results and a method for measuring impedance of the water electrolysis device including the anodic electrode according to the embodiment of the present disclosure. Impedance was measured at a cell voltage of 2.0 V_{cell} applied at an AC frequency of 50 kHz to 100 mHz in an equivalent electrical circuit model. The equivalent circuit includes an ohmic resistor (R_{Ω}) and two motion resistors, a high-frequency resistor (R_{hf}) and a low-frequency resistor (R_{lf}) and is connected in parallel with a regular phase element (CPE). The R_{Ω} is indicated by a high frequency cutoff of EIS. The R_{hf} is caused by charge transfer of a rate-determining step of OER, and the R_{hf} to a mass transport phenomenon, respectively. Fitting results are illustrated in Table 1.

TABLE 1

| | R_{Ω} | R_{hf} | R_{lf} | CPE_{hf} | | CPE_{lf} | |
|---|---|---|---|---|---|---|---|
| | (mΩ | (mΩ | (mΩ | (Ω⁻¹ sⁿ/ | | (Ω⁻¹ sⁿ/ | |
| DIVISION | cm²) | cm²) | cm²) | cm²) | n | cm²) | n |
| EIROF 5 min | 114.6 | 7.89 | 10.13 | 0.018 | 1 | 3.14 | 0.59 |
| EIROF 10 min | 119.5 | 7.00 | 11.00 | 0.034 | 1 | 6.24 | 0.50 |
| Fe₂N@EIROF | 78.5 | 2.57 | 5.50 | 0.054 | 1 | 3.45 | 0.71 |
| 1 min | | | | | | | |
| Fe₂N@EIROF | 70.7 | 2.89 | 6.47 | 0.053 | 1 | 3.16 | 0.66 |
| 3 min | | | | | | | |
| Fe₂N@EIROF | 68.3 | 3.48 | 10.72 | 0.055 | 1 | 4.36 | 0.66 |
| 5 min | | | | | | | |
| Fe₂N@EIROF | 69.1 | 3.53 | 12.43 | 0.051 | 1 | 4.39 | 0.63 |
| 10 min | | | | | | | |

### 2. Evaluation Results

Referring to FIGS. 17A to 17H, in case of the Ti fiber with the deposition time (t_{dep}) of 1 minute and 3 minutes, spectra do not fit the proposed equivalent circuit model due to abnormal behavior in a high-frequency region. In particular, anomaly is observed in a low-performance water electrolysis cell, but an origin of impedance characteristics in the high-frequency region is unclear. When more iridium is deposited on the Ti fiber, a Nyquist plot consisting of two semicircles is observed and may be fitted to the proposed equivalent circuit model. In case of the anodic electrode in which the iridium oxide layer is deposited on the metal nitride-deposited Ti fiber, the Nyquist plot consisting of two semicircles is observed even when the deposition time (t_{dep}) is 1 minute.

In addition, a positive effect due to the metal nitride may be confirmed in terms of reduced R_{hf} and R_{Ω}. For the anodic electrode in which the iridium oxide layer was deposited on the metal nitride-deposited Ti fiber, an average R_{hf} was measured to be 3.1 mΩ cm², which is much lower than 7.89 mΩ cm² (t_{dep}=5 minutes) and 7.00 mΩ cm² (t_{dep}=10 minutes) on the Ti fiber. The decrease of R_{hf} means that the metal nitride support body may effectively reduce the oxygen evolution reaction (OER) charge transfer resistance and improve the performance of the water electrolysis device. The decrease in R_{Ω} may also be observed. For the anodic electrode in which the iridium oxide layer was deposited on the metal nitride-deposited Ti fiber, an average R_{Ω} was measured to be 71.6 mΩ cm², which is lower than 114.6 mΩ cm² (t_{dep}=5 minutes) and 119.5 mΩ cm² (t_{dep}=10 minutes) on the Ti fiber.

In addition, mass transfer of PEMWE is greatly improved by introducing the porous structure on the catalyst layer. For an anodic electrode with an iridium oxide layer deposited on the metal nitride-deposited Ti fiber, the lowest R_{lf} of 5.50 mΩ cm² is exhibited at t_{dep}=1 minute. However, as the iridium oxide layer on the metal nitride becomes thicker, R_{lf} gradually increases as the iridium oxide blocks the porous structure of the metal nitride nanoarray.

### <Experimental Example 11> Evaluation of Mass Activity 1

### 1. Method of Evaluation

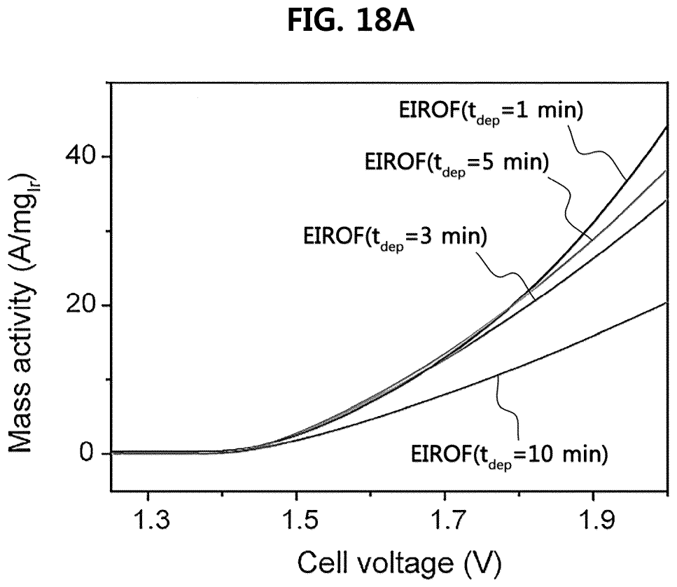

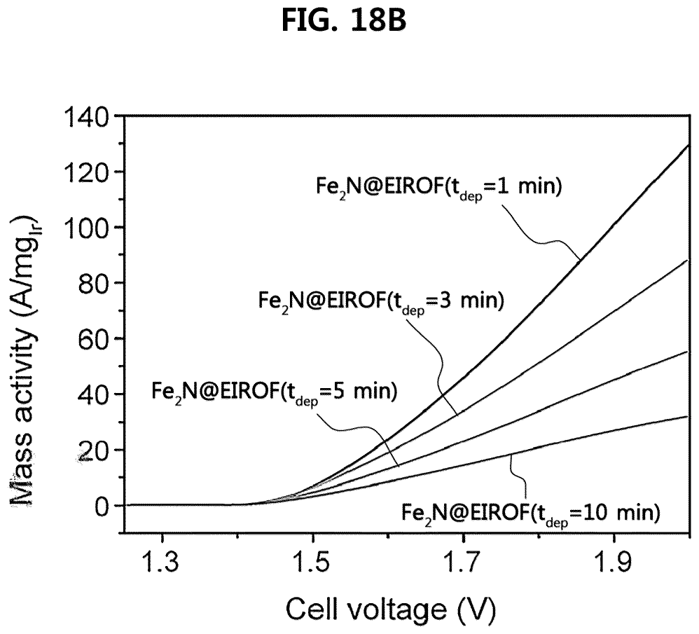

Mass activity was evaluated for the water electrolysis device including the anodic electrode according to the embodiment of the present disclosure. Results are illustrated in FIGS. 18A and 18B. FIGS. 18A and 18B are graphs illustrating the mass activity of the water electrolysis device including the anodic electrode according to the embodiment of the present disclosure. Mass activity of Ir is calculated by dividing current density by an Ir loading amount.

### 2. Evaluation Results

Whereas the iridium oxide deposited on the Ti fiber for 1 to 5 minutes exhibits similar mass activity when an applied voltage is less than 1.75 V_{cell}, a decrease in mass activity is observed at a higher applied voltage. The decrease in mass activity at the high applied voltage is expected to occur due to mass transport limitation. When the deposition time (t_{dep}) increases to 10 minutes, a sharp reduction in Ir mass activity is observed, and it may be confirmed that internal iridium oxide nanoparticles of the thick iridium oxide layer do not participate effectively in an oxygen evolution reaction (OER). It may be expected that the Ir mass activity is greatly enhanced by replacing the internal iridium oxide with a conductive metal nitride.

As expected, the iridium oxide on the metal nitride-coated Ti fiber exhibited a higher mass activity than the iridium oxide on the Ti fiber (FIG. 18B).

In case of the anodic electrode in which the iridium oxide layer is deposited on the Ti fiber deposited with the metal nitride, when the deposition time (t_{dep}) is 1 minute, high mass activity of 103.4 A/mg_{Ir} at 1.9 V is exhibited, which is 3.2 times higher than the iridium oxide on the Ti fiber.

### <Experimental Example 12> Evaluation of Mass Activity 2

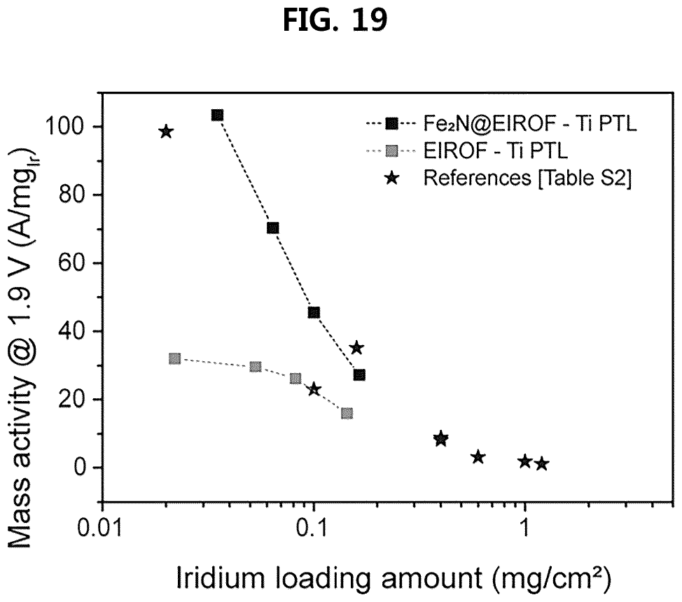

For the water electrolysis device including the anodic electrode according to the embodiment of the present disclosure, Ir mass activity of a previously reported Ir-based water electrolysis device was compared. Results are illustrated in FIG. 19 and Table 2. FIG. 19 is a graph illustrating mass activity of the water electrolysis device including the anodic electrode according to the embodiment of the present disclosure.

TABLE 2

| | | | | | Current | Current | Mass | Mass |
|---|---|---|---|---|---|---|---|---|
| | | Catalyst | | Temper- | density | density | activity | activity |
| | | loading | Mem- | ature | at 1.6 V | at 1.9 V | at 1.6 V | at 1.9 V |
| source | division | (mg/cm²) | brane | (° C.) | (A/cm²) | (A/cm²) | (A/mg_{Ir}) | (A/mg_{Ir}) |
| Present | Fe₂N@EIROF | 0.035 | 212 | 80 | 0.88 | 3.61 | 25.3 | 103.4 |
| disclosure | (t_{dep} = 1 min) | | | | | | | |
| | Fe₂N@EIROF | 0.064 | | | 1.23 | 4.50 | 19.3 | 70.3 |
| | (t_{dep} = 3 min) | | | | | | | |
| | Fe₂N@EIROF | 0.098 | | | 1.33 | 4.54 | 13.3 | 45.8 |
| | (t_{dep} = 5 min) | | | | | | | |
| | Fe₂N@EIROF | 0.165 | | | 1.42 | 4.48 | 8.60 | 27.16 |
| | (t_{dep} = 10 min) | | | | | | | |
| Non-patent | IrO₂@TiO₂ | 0.4 | 212 | 80 | 0.50 | 3.25 | 1.25 | 8.12 |
| document 1 | | | | | | | | |
| Non-patent | IrO₂/Pt | 0.16 | 212 | 80 | 1.17 | 5.63 | 7.31 | 35.2 |
| document 2 | | | | | | | | |
| Non-patent | IrO₂ inverse- | 0.02 | 212 | 90 | 0.83 | 1.97 | 41.5 | 98.5 |
| document 3 | opal | | | | | | | |
| Non-patent | IrO₂ | 0.60 | 115 | 90 | 0.55 | 1.87 | 0.91 | 3.11 |
| document 4 | | | | | | | | |
| Non-patent | Electro- | 0.1 | 112 | 90 | 1.02 | 2.30 | 10.2 | 23.0 |
| document 5 | deposited IrO₂ | | | | | | | |
| | electrode | | | | | | | |
| Non-patent | Ir ND/ATO | 1.0 | 212 | 80 | 0.69 | 1.85 | 0.69 | 1.85 |
| document 6 | | | | | | | | |
| Non-patent | 60% IrO₂-ATO | 1.2 | 115 | 80 | 0.2 | 1.32 | 0.16 | 1.1 |
| document 7 | | | | | | | | |

### 2. Evaluation Results

Referring to FIG. 19, in the water electrolysis device including the anodic electrode according to the embodiment of the present disclosure, compared to previous studies such as (non-patent document 0001) Appl. Catal. B: Environ. 269, 118762 (2020); (non-patent document 0002) Appl. Catal. B: Environ. 272, 118955 (2020); (non-patent document 0003) Nano Energy 58, 158-166 (2019); (non-patent document 0004) Appl. Catal. B: Environ. 182, 153-160 (2016); (non-patent document 0005) Appl. Catal. B: Environ. 179, 285-291 (2015); (non-patent document 0006) Chem. Sci. 6, 3321-3328 (2015); (non-patent document 0007) J. Power Soc. 269, 451-460 (2014), it may be confirmed that excellent mass activity is exhibited with a small Ir catalyst loading amount.

However, the mass activity of the anodic electrode according to the embodiment of the present disclosure rapidly decreases as the deposition time (t_{dep}) increases, but the current density of the water electrolysis cell increases due to the introduction of metal nitride. Therefore, the performance of the water electrolysis device depends more on mass transport resistance than the oxygen evolution reaction (OER) charge transfer resistance, and thus mass activity according to the plating time (t_{dep}) decreases.

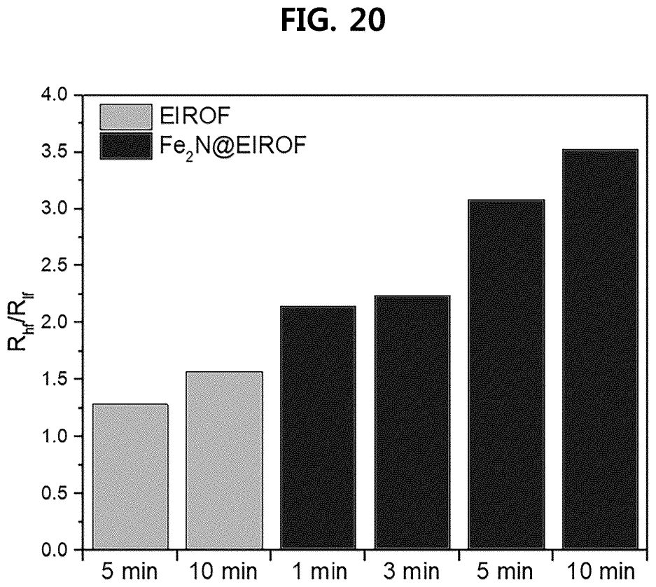

FIG. 20 is a graph illustrating a ratio (R_{hf}/R_{lf}) of high frequency resistance (R_{hf}) and low frequency resistance (R_{lf}) in the anodic electrode according to the embodiment of the present disclosure. Referring to FIG. 20, R_{lf}/R_{hf} in the anodic electrode according to the embodiment of the present disclosure is much higher. In addition, an increase in R_{lf}/R_{hf} according to the deposition time (t_{dep}) indicates that the performance of the water electrolysis device is mainly limited by the mass transport resistance.

### <Experimental Example 13> Evaluation of Stability 1

### 1. Method of Evaluation

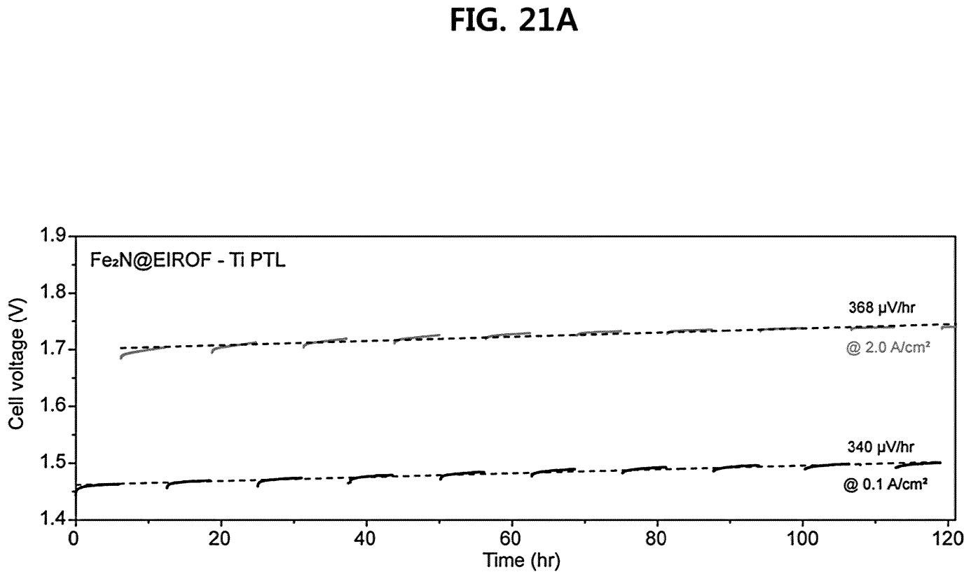

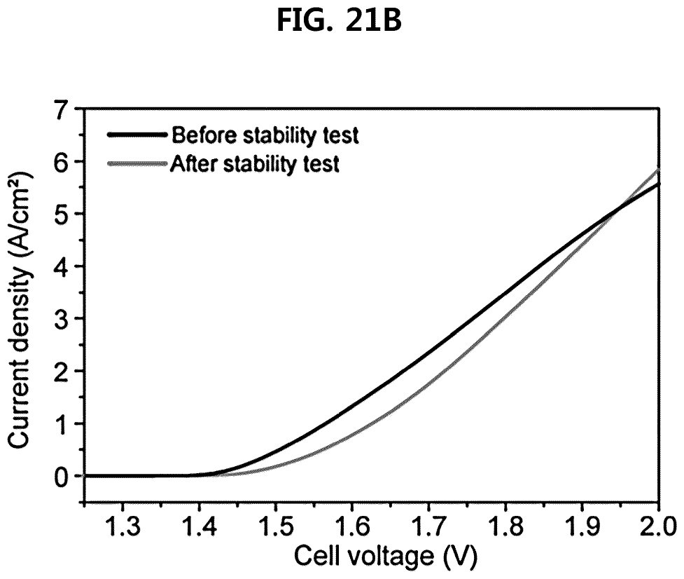

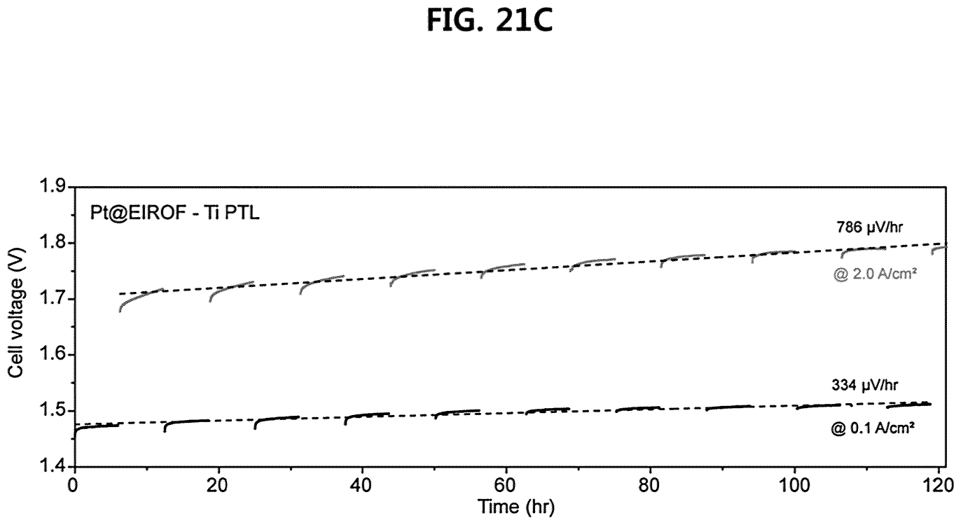

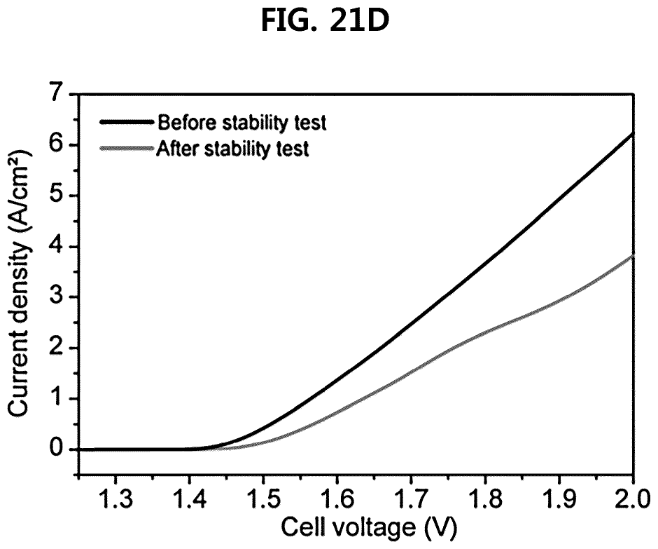

Stability of the anodic electrode on which the iridium oxide is deposited was evaluated with the deposition time of 5 minutes (t_{dep}) on the metal nitride-deposited Ti fiber. For comparison, the anodic electrode in which the iridium oxide is deposited on the Ti fiber on which platinum was deposited was prepared. A similar amount of Ir was deposited on both anodic electrodes. A polymer electrolyte membrane water electrolysis (PEMWE) device including the anodic electrode was prepared. Performance and durability of the PEMWE were evaluated under a dynamic operation condition. Specifically, cycled square-wave galvanic input alternating current density between 0.1 A/cm² and 2.0 A/cm², respectively, for 6 hours was applied to PEMWE for a total of 120 hours. It was applied to PEMWE for an extended period of time, totaling 120 hours. Results of average values after measuring three times are illustrated in FIGS. 21A to 21D. FIGS. 21A to 21D are graphs illustrating stability evaluation results and linear sweep voltammetry (LSV) polarization curves of the water electrolysis device including the anodic electrode according to the embodiment of the present disclosure.

### 2. Evaluation Results

Referring to FIGS. 21A to 21D, at a low current density of 0.1 A/cm², a decomposition rate was 340 μV/hr for the anodic electrode according to the embodiment and 334 μV/hr for the anodic electrode according to a comparative example, and the decomposition rate was found to be similar to each other (FIGS. 21A and 21C). In contrast, at a high applied current density of 2.0 A/cm², a decomposition rate was 368 μV/hr for the anodic electrode according to the embodiment, and 788 μV/hr for the anodic electrode according to the comparative example, and the decomposition rate of the anodic electrode according to the embodiment was found to be low.

In addition, referring to FIGS. 21A to 21D, after the stability test, the LSV indicates that the water electrolysis performance of the anodic electrode according to the comparative example is more deteriorated than that of the anodic electrode according to the embodiment (FIGS. 21B and 21D).

### <Experimental Example 14> Evaluation of Stability 2

### 1. Method of Evaluation

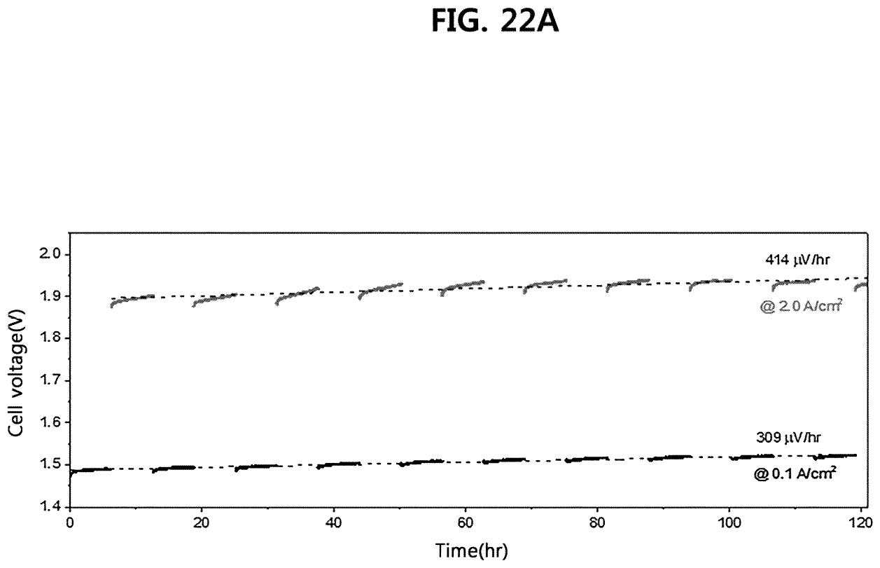

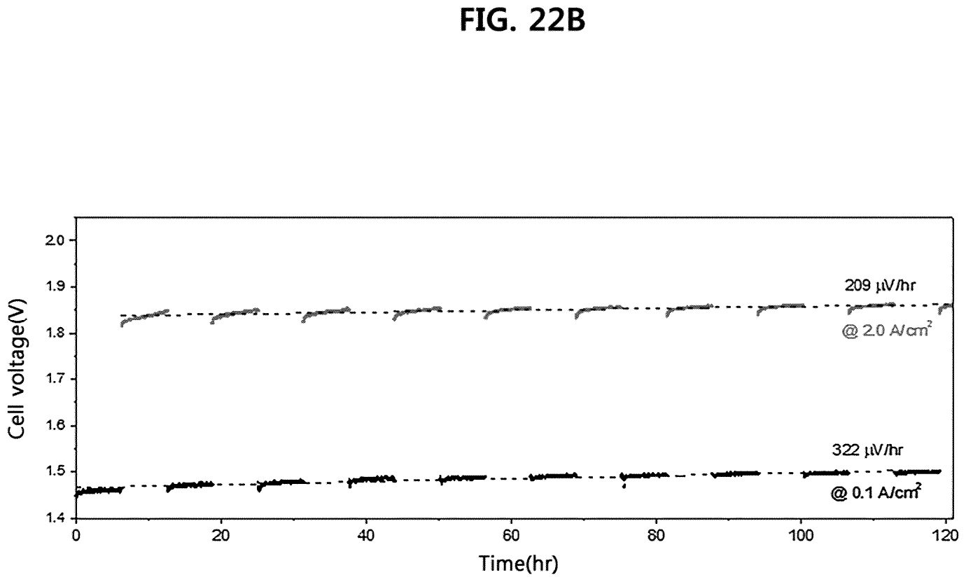

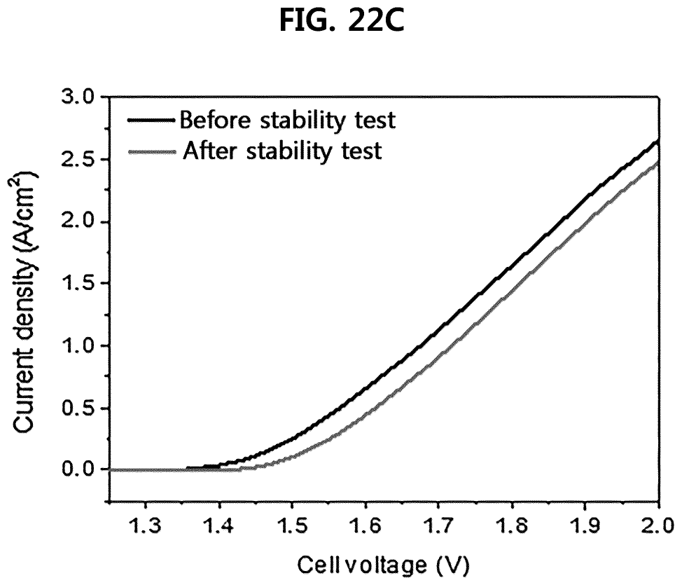

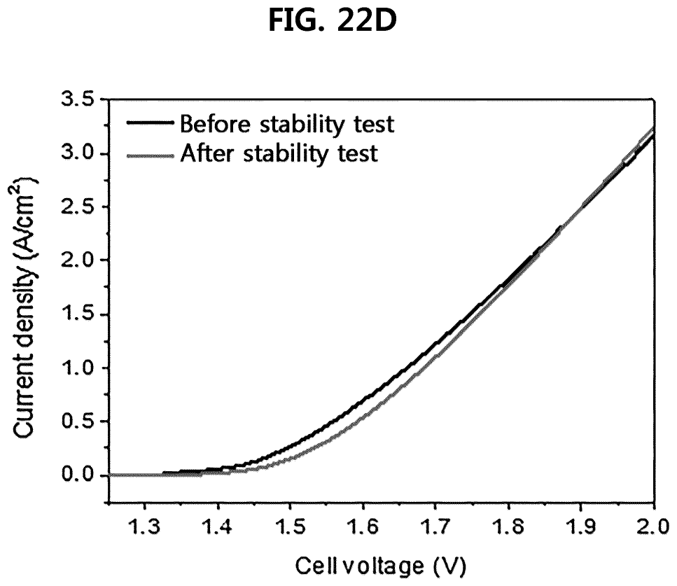

In order to evaluate whether the stability of the water electrolysis device depends on a type of membrane, in the preparation of the membrane electrode assembly, the stability was evaluated in the same manner as in the experimental example 13, except that the Nafion™ 115 membrane (50 μm, DuPont) was used instead of the Nafion™ 212 membrane (50 μm, DuPont). Results of average values after measuring three times are illustrated in FIGS. 22A to 22D. FIGS. 22A to 22D are graphs illustrating stability evaluation results and linear sweep voltammetry (LSV) polarization curves of the water electrolysis device including the anodic electrode according to the embodiment of the present disclosure.

### 2. Evaluation Results

Referring to FIGS. 22A to 22D, at a low current density of 0.1 A/cm², the decomposition rate was 309 μV/hr for the anodic electrode according to the embodiment and 322 μV/hr for the anodic electrode according to the comparative example and the decomposition rates were similar to each other (FIGS. 22A and 22C). In contrast, at a high applied current density of 2.0 A/cm², the decomposition rate was 209 μV/hr for the anodic electrode according to the comparative example, which was much lower than that of the Nafion™ 212 membrane (788 μV/hr). At the high applied current density of 2.0 A/cm², the decomposition rate was 414 μV/hr for the anodic electrode according to the embodiment, which was higher than that of the Nafion™ 212 membrane (368 μV/hr).

In addition, referring to FIGS. 22A to 22D, after the stability test, the LSV indicates that the water electrolysis performance of the anodic electrode according to the embodiment is still maintained (FIGS. 22B and 22D). Therefore, it may be confirmed that the metal nitride of the anodic electrode according to the embodiment serves a practical role as a support body of the iridium oxide and a protective layer of the Ti fiber.

### <Experimental Example 15> Observation of Distribution of Iridium Oxide

### 1. Method of Evaluation

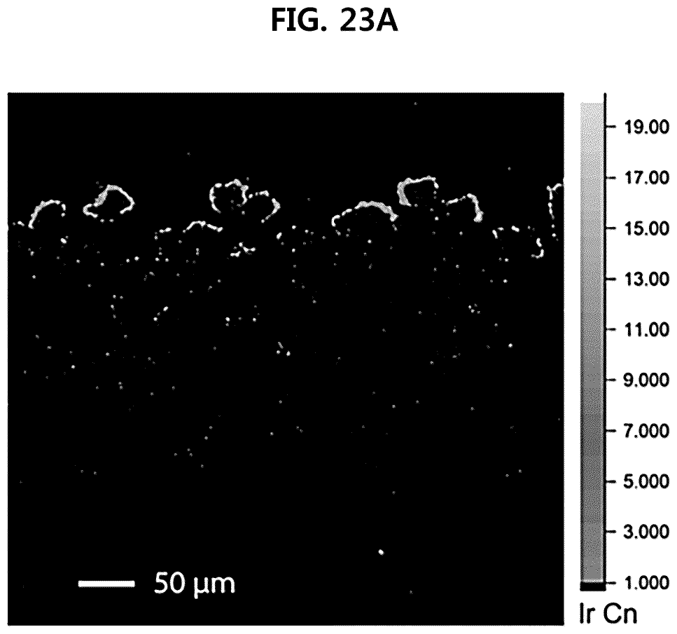

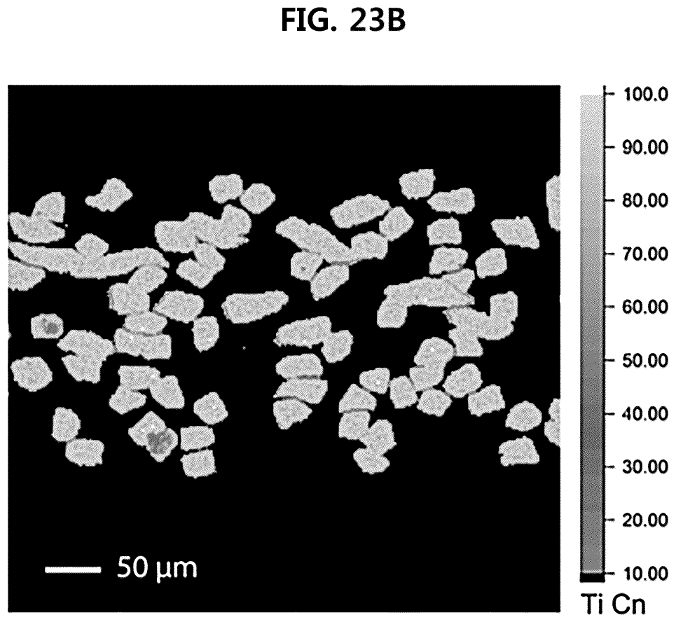

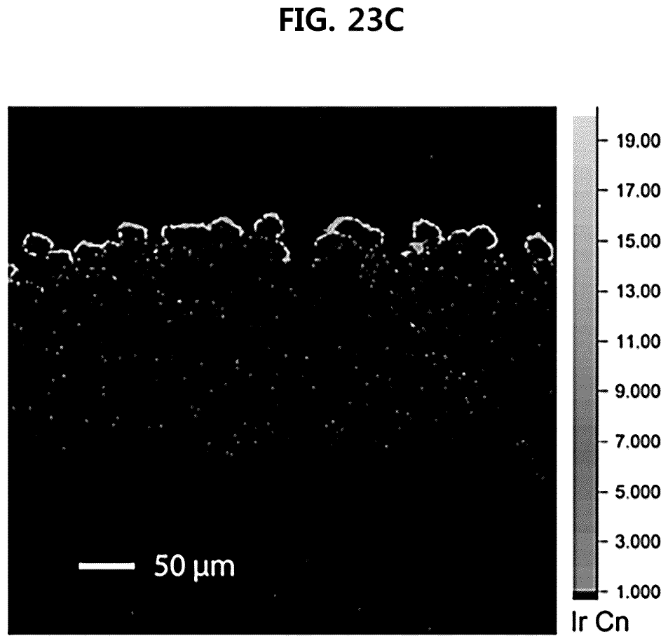

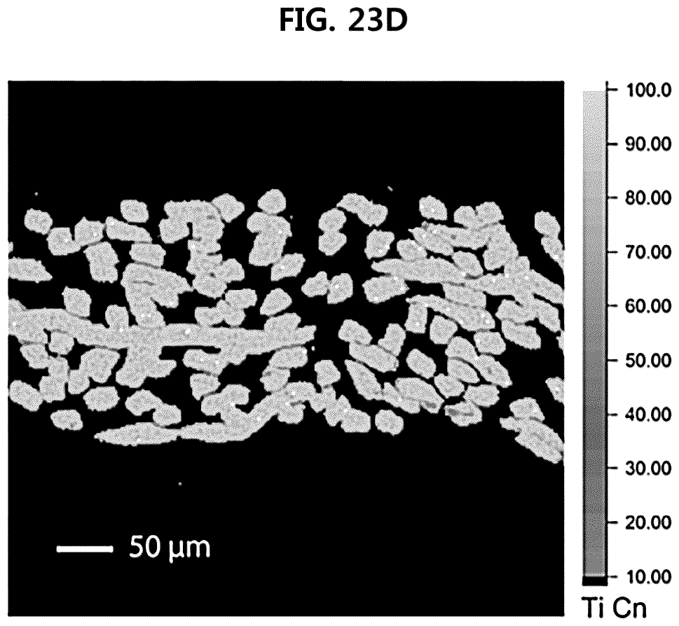

A Ti PTL composed of several layers of Ti microfibers with a thickness of 250 μm and a diameter of 20 to 30 μm was prepared. Elemental mapping analysis was performed on the Ti fiber with metal nitride and iridium oxide deposited and the Ti fiber without metal nitride and with iridium oxide deposited using SEM-WDS, which is a scanning electron microscope (SEM) coupled to a wave length dispersive X-ray spectroscopy (WDS). Results are illustrated in FIGS. 23A to 23D. FIGS. 23A to 23D are SEM-WDS images illustrating a cross section of the anodic electrode according to the embodiment of the present disclosure.

### 2. Evaluation Results

Referring to FIGS. 23A to 23D, it may be confirmed that most of Ir is deposited from an outer surface of the Ti PTL to a depth of about 50 μm corresponding to first to second layers of Ti microfiber in the Ti fiber on which iridium oxide is deposited without metal nitride deposited. It may be confirmed that even in the Ti fiber on which metal nitride and iridium oxide are deposited, Ir is deposited only on surfaces of first to second layers of the Ti microfiber.

### <Experimental Example 16> Evaluation of Role of Ionomer Binder

### 1. Method of Evaluation

In order to confirm whether a presence of an ionomer in the catalyst layer is a necessary condition for an operation of high-performance PEMWE, a role of an ionomer binder on the oxygen evolution reaction (OER) activity was evaluated.

When bonding the coated Ti PTL to a Nafion membrane, there are two different interfacial contacts. One is an iridium oxide layer deposited on the outermost side of the Ti PTL facing the Nafion membrane (denoted as EIROF_{Nafion}). The other is an iridium oxide layer deposited on an inside of the Ti PTL facing water (denoted as EIROF_{water}). Assuming that the catalyst in contact with the Nafion membrane is an active site, it may be assumed that EIROF_{Nafion} will be a reactive site which dominates the overall PEMWE performance.

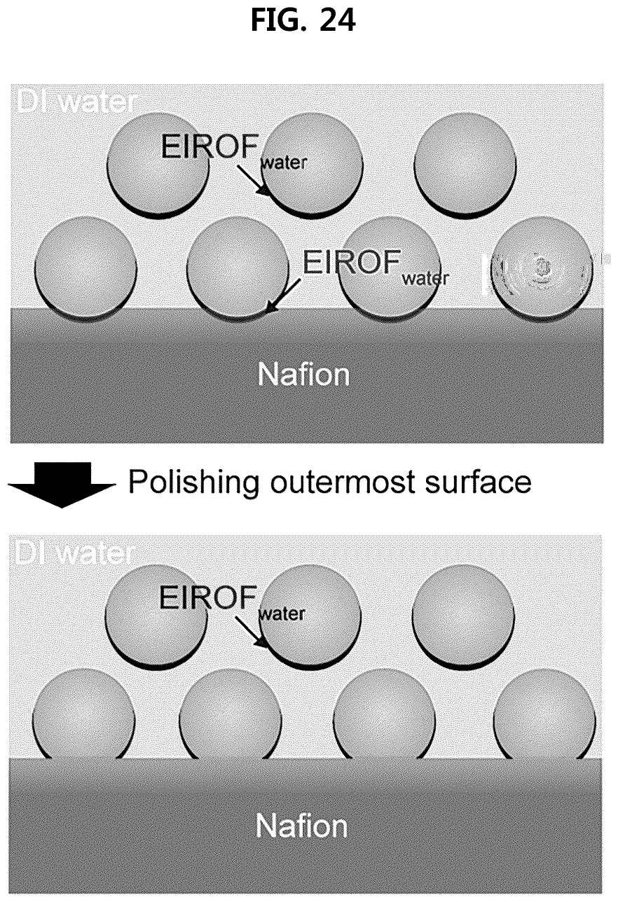

The iridium oxide layer of the Ti PTL was removed by polishing to investigate the interface governing catalytic utilization. A degree of surface polishing was controlled by measuring a thickness of the Ti PTL with a digital thickness gauge during polishing. The thickness of the Ti PTL was measured at 5 points and averaged. The thickness change was controlled to about 5 μm. Assuming that EIROF_{Nafion} mainly accounts for the water oxidation reaction, it may be assumed that the PEMEC performance will be greatly deteriorated by removing the iridium oxide on the outermost layer of Ti PTL in contact with the Nafion membrane. FIG. 24 is a schematic view illustraing the anodic electrode polishing according to the embodiment of the present disclosure.

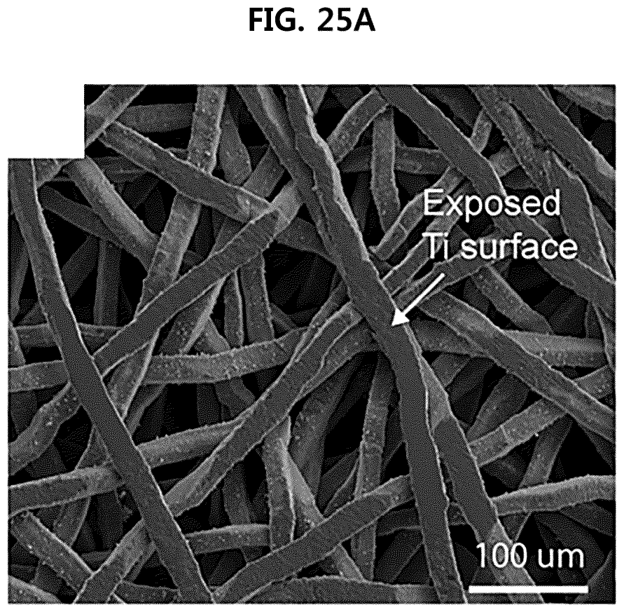

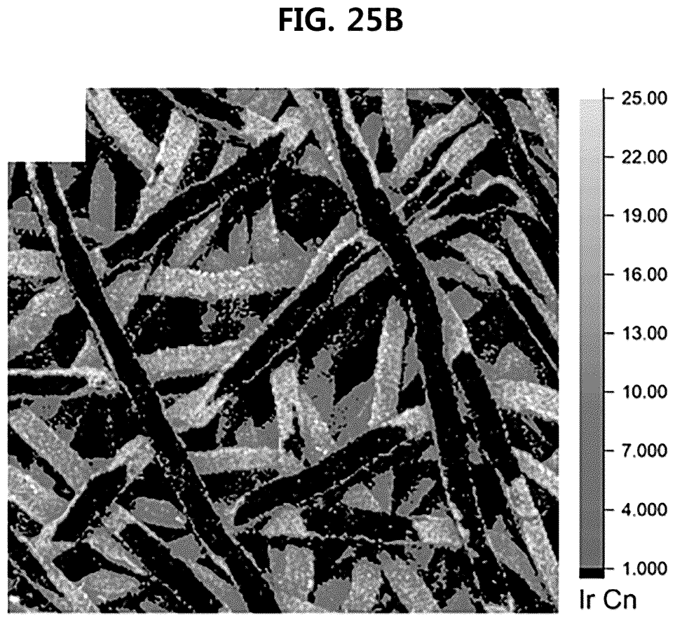

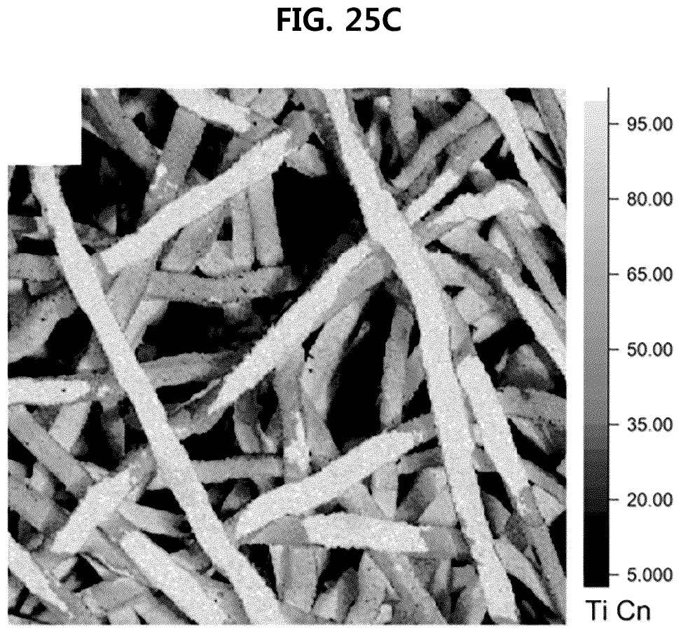

After polishing, the distribution of Ir on the Ti PTL was analyzed through electron probe microanalysis (EPMA). FIGS. 25A to 25C are EPMA images illustrating Ir distribution of the anodic electrode according to the embodiment of the present disclosure. Referring to FIGS. 25A to 25C, it may be clearly confirmed that the EIROF has been removed and the underlying Ti surface is exposed on the outermost surface of the Ti PTL, while the EIROF on a second Ti fiber is intact.

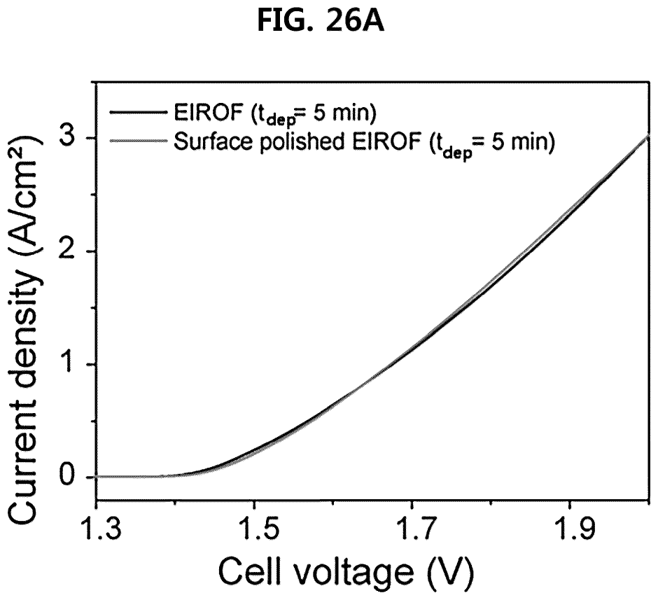

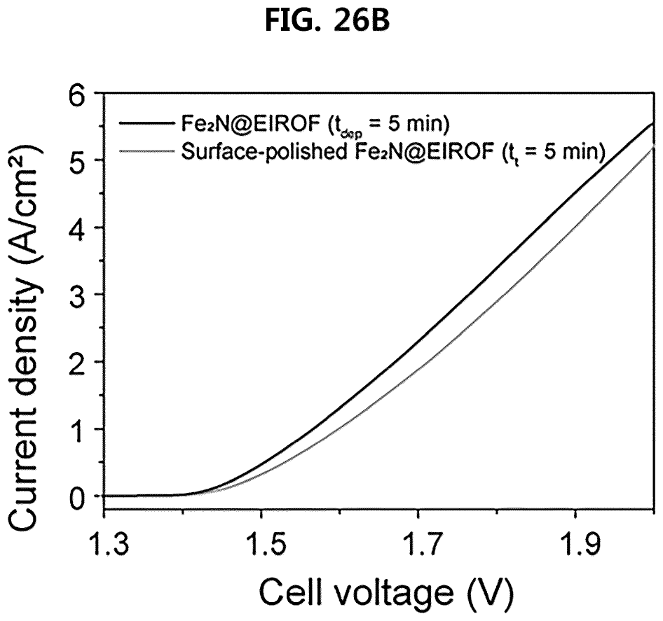

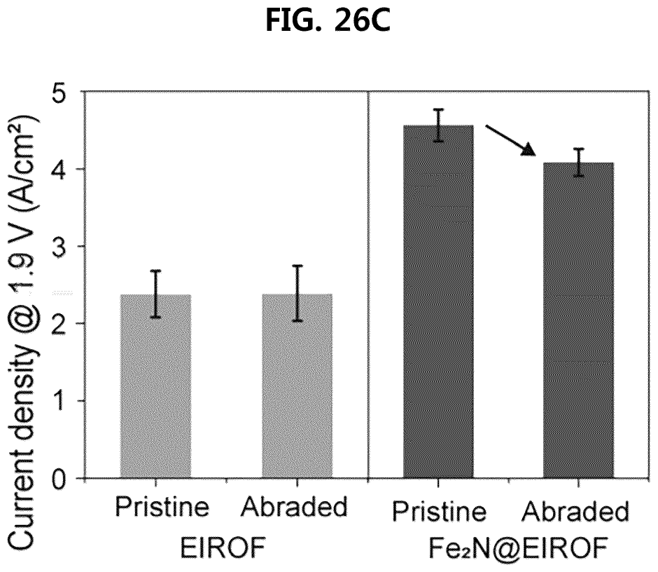

The water electrolysis cell was prepared using the electrode. The water electrolysis performance of the water electrolysis cell was evaluated. Results are illustrated in FIGS. 26A to 26C. FIGS. 26A to 26C are graphs illustrating I-V polarization curves of the water electrolysis device including the anodic electrode according to the embodiment of the present disclosure.

### 2. Evaluation Results

Referring to FIGS. 26A to 26C, when metal nitride (Fe₂N) layer is not deposited, it may be confirmed that the PEMWE performance does not be deteriorated even though the EIROF that will be in contact with the Nafion membrane is removed (FIG. 26A). This result indicates that the iridium oxide deposited on the internal Ti fiber not in contact with the Nafion membrane dominates the overall PEMWE performance, whereas the iridium oxide adhering to the Nafion membrane does not affect the overall PEMWE performance. In general, since deionized water has high ionic resistance, a presence of Nafion ionomer was considered important for the transfer of protons from the catalyst layer to the Nafion membrane. However, the above result indicates that protons may be transported from the catalyst surface to the Nafion membrane even when the catalyst is not in direct contact with Nafion. Therefore, from the above result, it may be predicted that an increased ion concentration by the protons generated by the water oxidation reaction may increase ionic conductivity of water between the catalyst layer and the Nafion membrane. Accordingly, PEMWE may be operated without applying the Nafion ionomer on the surface of the anodic electrode.

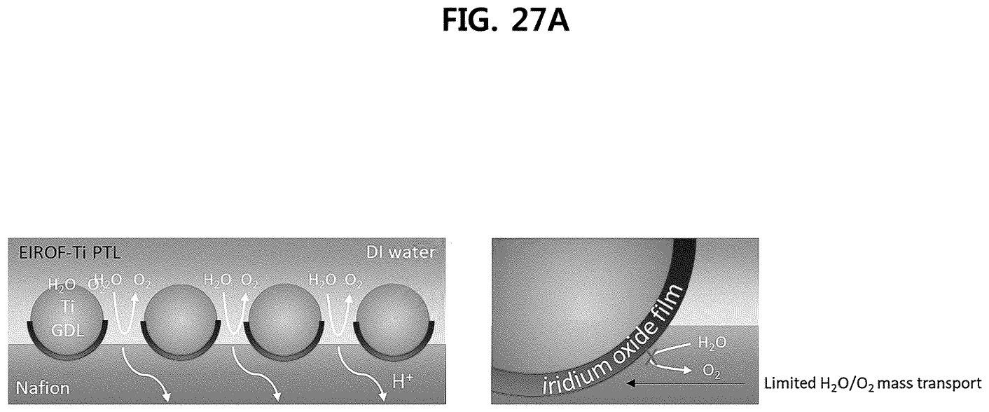

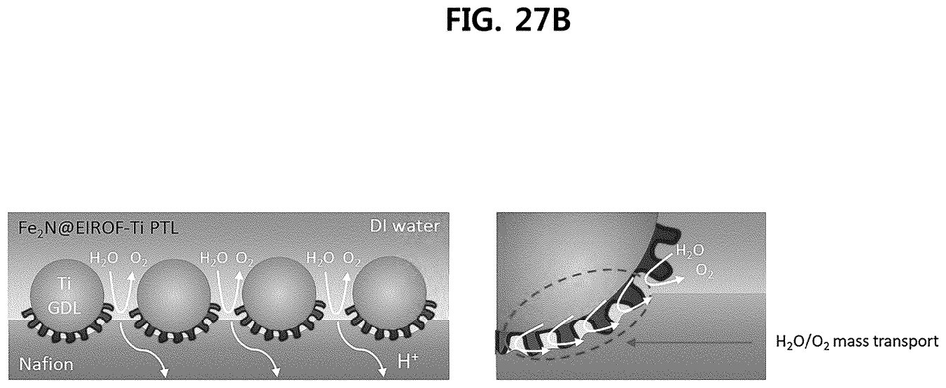

Referring to FIGS. 26A to 26C, when the metal nitride (Fe₂N) layer is deposited, the current density decreases, indicating that the outermost layer is active against the OER (FIG. 26B). This difference between the case where the metal nitride layer is deposited and the case where the metal nitride is not deposited may be predicted to be caused by the difference in morphologies of the catalyst layer. In case that the metal nitride layer is not deposited, since the catalyst layer has a dense planar Ir layer, when the EIROF_{nafion} interface and the Nafion membrane are in contact, it may be expected that there will be no gap between the EIROF_{nafion} interface and the Nafion membrane. Accordingly, when the Nafion membrane covers the surface of EIROF, water transport to the active site of the catalyst is limited, resulting in low activity of EIROF_{nafion}. FIGS. 27A and 27B is schematic views illustrating an operation of the anodic electrode according to the embodiment of the present disclosure.

On the contrary, since the metal nitride nanowire structure provides pores through which water can move, EIROF on the metal nitride nanowires may also participate in the OER (FIG. 27B). Therefore, by removing the outermost layer of the electrode, the PEMWE current density decreases, but the EIROF/Ti current density does not change significantly (FIG. 26C).

While exemplary embodiments of the present disclosure have been described above with reference to the above-mentioned preferred embodiments, various modifications and alterations may be made without departing from the subject matter and the scope of the disclosure. Accordingly. the appended claims include the modifications or alterations as long as the modifications or alterations fall within the subject matter of the present disclosure.

1. An anodic electrode comprising:
a substrate;
a metal nitride layer formed on the substrate; and
an iridium oxide layer formed by an electrodeposition on the metal nitride layer.

2. The anodic electrode of claim 1, wherein the metal nitride layer comprises metal nitride nanowires.

3. The anodic electrode of claim 2, wherein the metal nitride nanowires are oriented in at least one or more directions.

4. The anodic electrode of claim 2, wherein the metal nitride nanowire has a rough surface.

5. The anodic electrode of claim 2, wherein the metal nitride nanowire has a diameter of 10 nm to 100 nm, and a length of 200 nm to 800 nm.

6. The anodic electrode of claim 1, wherein the iridium oxide layer has a thickness of 10 nm to 50 nm.

7. The anodic electrode of claim 1, wherein the metal nitride comprises one or more nitrides selected from a group consisting of magnesium (Mg), scandium (Sc), titanium (Ti), vanadium (V), chromium (Cr), manganese (Mn), iron (Fe), cobalt (Co), nickel (Ni), copper (Cu), zinc (Zn) and lead (Pb).

8. The anodic electrode of claim 1, wherein a weight of the iridium oxide layer per unit area of the anodic electrode is 0.2 mg/cm² or less.

9. The anodic electrode of claim 1, wherein the substrate is titanium paper composed of titanium fibers.

10. A water electrolysis device comprising the anodic electrode according to claim 1.
